(19) United States
(12) Patent Application Publication
(10) Pub. No.: US 2025/0175119 A1
(43) Pub. Date: May 29, 2025

(54) Solar Palm Tree

(71) Applicant: Palm Energy Systems LLC, Cos Cob, CT (US)

(72) Inventors: Rajiv Narain, New Delhi (IN); Francois Mahu, Mumbai (IN)

(21) Appl. No.: 18/842,837

(22) PCT Filed: Feb. 28, 2023
(86) PCT No.: PCT/US23/63387

§ 371 Date: Aug. 30, 2024

Related U.S. Application Data
(60) Provisional application No. 63/268,710, filed on Mar. 1, 2022.

(51) Int. Cl. H02S 20/32

(52) U.S. Cl. CPC H02S 20/32

(57) ABSTRACT

A palm tree solar panel apparatus includes a central pole, a sun-tracking fulcrum, and a plurality of solar panel petals. The sun-tracking fulcrum is connected to the central pole. The plurality of solar panel petals is connected to the sun-tracking fulcrum. The sun-tracking fulcrum both rotates and tilts the plurality of solar panel pedals with respect to the location of the sun. Each petal of the plurality of solar panel petals includes an isosceles trapezoid that is curved from the shorter base to the longer base and is connected to the fulcrum at the shorter base. Each petal of the plurality of solar panel petals includes a top transparent and protective layer, a central solar photovoltaic layer, and a lower structural layer.

### RELATED APPLICATIONS

The present application claims the benefit of priority from U.S. Provisional Application No. 63/268,710, filed on Mar. 1, 2022, the entire contents of which is incorporated by reference herein.

### FIELD OF THE INVENTION

The teachings herein relate to a solar panel apparatus. More specifically, various embodiments include an apparatus resembling a palm tree that is used to convert energy from the sun into electrical energy and a method for assembling that apparatus.

### DESCRIPTION OF THE PRIOR ART

The mainstay of the solar energy industry has been the solar photovoltaic panel, which in its form and structure has come to symbolize solar energy systems, as we know them today. The physical characteristics of the conventional solar panel are determined by its form and structure. They are generally rectangular in shape measuring approximately 1.0 meters wide by 2.0 meters long by 3.5 centimeters thick (varies based on manufacturer).

Due to its form and technical limitations, the solar panel has acquired a quality that has taken it either far away from the city or along the city skyline, on roofs, hidden or camouflaged from view. It has become a technical appendage, where technical criteria outweigh all other considerations. The recognition of these limitations has unleashed a wave of new research focused on finding better ways to integrate the power-producing silicon chip into roof tiles or roof assemblies, to produce camouflaged rooftop panels, both of which address the needs of a residential aesthetic.

One new way to integrate solar panels in the urban habitat, which has witnessed limited development and application, is popularly known as the solar tree, which is a ground-mounted solar energy device, with a form inspired by a tree. This solar tree typically consists of a central post (trunk), which branches out as it rises upwards, with each branch supporting a flat rectangular or circular conventional solar panel. While each model differs in size, design, power rating, and efficiency, they are uniform in their industrial aesthetic and an inability to effectively mimic the qualities of a natural tree.

Due to their size, shape, power rating, and high unit cost, their usage has been limited to isolated exhibits within parks and institutions or as canopies for car parks and gas stations. Some solutions provide mobile energy platforms for use during emergencies and as mobile Electrical Vehicle (EV) charging facilities. The form and structure of a majority of alternatives do not allow for pedestrian or vehicular movement underneath. A few allow for pedestrian movement underneath, while none of them allow for vehicular movement underneath.

As a result, new apparatus and methods are needed to integrate solar panels into a solar tree in the urban habitat.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram illustrating certain of the primary components, elements, and processes present in an implementation of the inventive clean energy system, the Palm-e System (PeS), in accordance with various embodiments.

FIG. 2 is a block diagram illustrating certain of the primary components, elements, and processes of the Array Control Module (ACM) that are used in an implementation of the inventive clean energy system, the Palm-e System (PeS), in accordance with various embodiments.

FIG. 3 is a block diagram illustrating certain of the primary components, elements, and processes of the Solar Energy System that are used in an implementation of the inventive clean energy system, the Palm-e System (PeS), in accordance with various embodiments.

FIG. 4 is a block diagram illustrating certain of the primary components, elements, and processes of the Energy Control Module (ECM) that are used in an implementation of the inventive clean energy system, the Palm-e System (PeS), in accordance with various embodiments.

FIG. 5 is an exemplary diagram of the Palm-e Small Footprint High Rise (PeS-SFHR) device, in accordance with various embodiments.

FIG. 6 is an exemplary diagram 600 showing an exploded view of the Palm-e Small Footprint High Rise (PeS-SFHR) device, in accordance with various embodiments.

FIG. 7 is an exemplary diagram showing three layers of a solar petal, in accordance with various embodiments.

FIG. 8 is an exemplary diagram showing a single surface supporting structure, in accordance with various embodiments.

FIG. 9 is an exemplary perspective view showing a three-dimensional supporting structure including two separate surfaces sandwiching a structural element, in accordance with various embodiments.

FIG. 10 is an exemplary cross-section view showing a three-dimensional supporting structure including two separate surfaces sandwiching a structural element, in accordance with various embodiments.

FIG. 11 is an exemplary diagram showing a structural element that includes a set of multiple cross-sections arranged parallel to each other and made of aluminum or steel or plastic or wood, in accordance with various embodiments.

FIG. 12 is an exemplary diagram showing a structural element that includes a triangulated network of metal tubes (steel or aluminum or composites) welded to each other to form a skeleton-like frame structure between the two surfaces, in accordance with various embodiments.

FIG. 13 is an exemplary diagram of an axis rotation system where both vertical and horizontal axis rotations are done by means of slewing drives, in accordance with various embodiments.

FIG. 14 is an exemplary diagram of an axis rotation system where the vertical axis rotation is undertaken using two double or single ball or roller bearings between the pole and a smaller steel rod or tube, in accordance with various embodiments.

FIG. 15 is an exemplary diagram of an axis rotation system where the horizontal axis rotation occurs in the fulcrum between the element attaching to the petal and the element attaching to the vertical axis system, in accordance with various embodiments.

FIG. 16 is an exemplary diagram showing perspective and cross-sectional views of a ring housing of a fulcrum, in accordance with various embodiments.

FIG. 17 is a flowchart showing a method for assembling a solar panel apparatus, in accordance with various embodiments.

FIG. 18 is a master flowchart or flow diagram illustrating a process, method, operation, or function to determine the various sequential steps to “execute barcode specific tasks” that may be used in an implementation of an embodiment of the inventive clean energy system, the Palm-e System (PeS).

FIG. 19 is a flowchart or flow diagram illustrating a process, method, operation or function to determine “design optimization/feasibility” of a specific clean energy system that may be used in an implementation of an embodiment of the inventive clean energy system, the Palm-e System (PeS).

FIG. 20 is a flow chart or flow diagram illustrating a process, method, operation or function to determine “device/system configuration-fixed parameters” of a specific clean energy system that may be used in an implementation of an embodiment of the inventive clean energy system, the Palm-e System (PeS).

FIG. 21 is a flowchart or flow diagram illustrating a process, method, operation or function to determine “device/system configuration-variable parameters” of a specific clean energy system that may be used in an implementation of an embodiment of the inventive clean energy system, the Palm-e System (PeS).

FIG. 22 is a flowchart or flow diagram illustrating a process, method, operation or function to determine “device/system installation” of a specific clean energy system that may be used in an implementation of an embodiment of the inventive clean energy system, the Palm-e System (PeS).

FIG. 23 is a flowchart or flow diagram illustrating a process, method, operation or function to determine “device/system activation” of a specific clean energy system that may be used in an implementation of an embodiment of the inventive clean energy system, the Palm-e System (PeS) 1000.

FIG. 24 is a first flowchart or flow diagram illustrating a process, method, operation or function to determine “device/system operation and optimization” of a specific clean energy system that may be used in an implementation of an embodiment of the inventive clean energy system, the Palm-e System (PeS).

FIG. 25 is a second flowchart or flow diagram illustrating a process, method, operation or function to determine “device/system operation and optimization” of a specific clean energy system that may be used in an implementation of an embodiment of the inventive clean energy system, the Palm-e System (PeS).

FIG. 26 is a flowchart or flow diagram illustrating a process, method, operation or function to determine “device/system monitoring” of a specific clean energy system that may be used in an implementation of an embodiment of the inventive clean energy system, the Palm-e System (PeS).

FIG. 27 is a first block diagram illustrating the user interface architecture that may be used in an implementation of an embodiment of the inventive clean energy system, the Palm-e System (PeS).

FIG. 28 is a second block diagram illustrating the user interface architecture that may be used in an implementation of an embodiment of the inventive clean energy system, the Palm-e System (PeS).

FIG. 29 is a third block diagram illustrating the user interface architecture that may be used in an implementation of an embodiment of the inventive clean energy system, the Palm-e System (PeS).

FIG. 30 is a fourth block diagram illustrating the user interface architecture that may be used in an implementation of an embodiment of the inventive clean energy system, the Palm-e System (PeS).

FIG. 31 is a first schematic line diagram illustrating a first version of the Palm-e SEHR ground mounted clean energy system that may be used in the implementation of an embodiment of the inventive clean energy system, the Palm-e System (PeS).

FIG. 32 is a second schematic line diagram illustrating a second version of the Palm-e SFHR ground mounted clean energy system that may be used in the implementation of an embodiment of the inventive clean energy system, the Palm-e System (PeS).

FIG. 33 is a third schematic line diagram illustrating a third version of the Palm-e SFHR ground mounted clean energy system that may be used in the implementation of an embodiment of the inventive clean energy system, the Palm-e System (PeS).

FIG. 34 is a diagram illustrating the application matrix of the Palm-e SFHR ground mounted clean energy system that may be used in the implementation of an embodiment of the inventive clean energy system, the Palm-e System (PeS).

FIG. 35 is a diagram illustrating the typological application of specific device models with respect to specific user applications that may be used in the implementation of an embodiment of the inventive clean energy system, the Palm-e System (PeS).

FIG. 36 is a rendering (view) of the SFHR device and certain of the components of the SFHR device illustrating the physical characteristics of the SFHR device and its primary elements, in accordance with various embodiments.

FIG. 37 is an exemplary side view of the SEHR device from an angle showing the top of the canopy, in accordance with various embodiments.

FIG. 38 is an exemplary rear view of the SFHR device from an angle showing the bottom of the canopy, in accordance with various embodiments.

FIG. 39 is an exemplary side view of the SFHR device from an angle showing the bottom of the canopy, in accordance with various embodiments.

FIG. 40 is an exemplary top view of the SFHR device, in accordance with various embodiments.

FIG. 41 is a first diagram illustrating the technology embodiments of the SFHR device and its primary components.

FIG. 42 is a second diagram illustrating the technology embodiments of the SFHR device and its primary components.

FIG. 43 is a second diagram illustrating the technology embodiments of the SFHR device and its primary components.

FIG. 44 is a second diagram illustrating the technology embodiments of the SEHR device and its primary components.

FIG. 45 is a drawing illustrating the movement characteristics of the solar corolla and certain features of the device, in accordance with various embodiments.

FIG. 46 is a drawing illustrating variations of the electronic cabinet—SeeD, which serves as the base station of the SFHR device, in accordance with various embodiments.

FIG. 47 is a technical drawing illustrating the physical characteristics of the SEHR device, in accordance with various embodiments.

FIG. 48 is an illustration depicting a first additional typology of the inventive clean energy device that may be used in the implementation of an embodiment of the inventive clean energy system, the Palm-e System (PeS).

FIG. 49 is an illustration depicting a second additional typology of the inventive clean energy device that may be used in the implementation of an embodiment of the inventive clean energy system, the Palm-e System (PeS).

Before one or more embodiments of the invention are described in detail, one skilled in the art will appreciate that the invention is not limited in its application to the details of construction, the arrangements of components, and the arrangement of steps set forth in the following detailed description or illustrated in the drawings and appendices. The invention is capable of other embodiments and of being practiced or being carried out in various ways. Also, it is to be understood that the phraseology and terminology used herein is for the purpose of description and should not be regarded as limiting.

### DESCRIPTION OF VARIOUS EMBODIMENTS

### SOLAR PALM TREE

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the invention will be described more fully hereinafter with reference to the accompanying drawings, which form a part hereof, and which show, by way of illustration, exemplary embodiments by which the invention may be practiced. This invention may, however, be embodied in many different forms and should not be construed as limited to the embodiments set forth herein; rather, these embodiments are provided so that this disclosure will satisfy the statutory requirements and convey the scope of the invention to those skilled in the art.

Among other things, the present invention may be embodied in whole or in part as a system, as one or more methods, as one or more elements of a clean energy device or clean energy system, as one or more elements or functional modules of a clean energy control system or clean energy control system, or as one or more devices. Embodiments of the invention may take the form of a hardware-implemented embodiment, a software-implemented embodiment, or an embodiment combining software and hardware aspects.

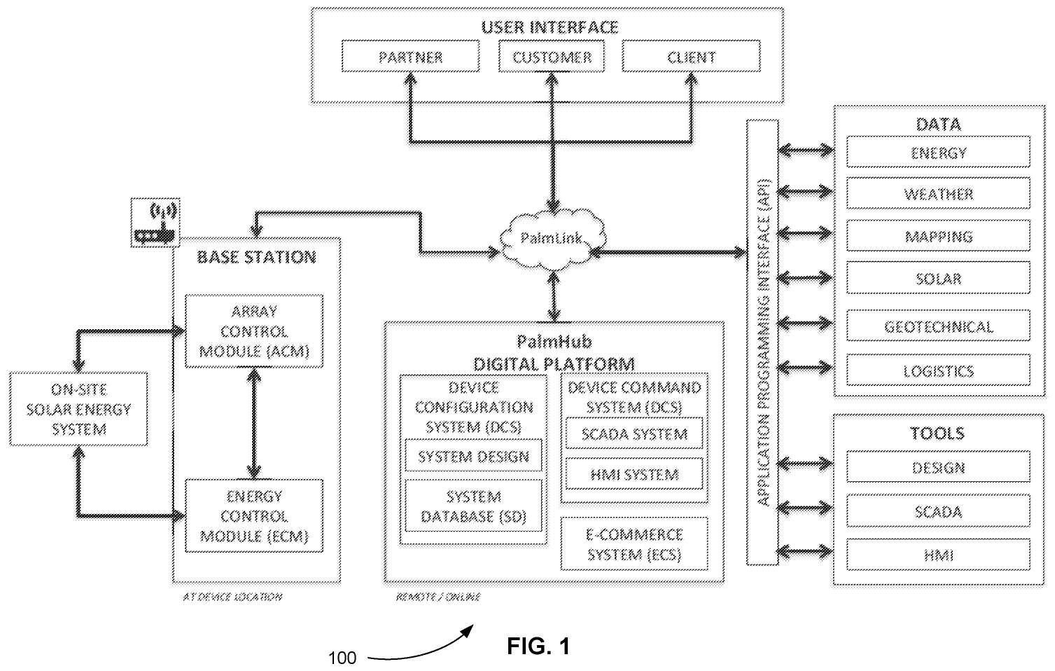

FIG. 1 is a block diagram 100 illustrating certain of the primary components, elements, and processes present in an implementation of the inventive clean energy system, the Palm-e System (PeS), in accordance with various embodiments. For example, in some embodiments, one or more of the operations, functions, processes, or methods described herein for use in the control (or other form of control) of a PeS SFHR device or of the PeS inventive clean energy system may be implemented by one or more suitable processing elements (such as a processor, microprocessor, CPU, controller, micro controller, etc.) that is part of a client device, server, or other form of computing or data processing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware. The following detailed description is, therefore, not to be taken in a limiting sense.

PeS comprises three integrated and interconnected components. First a Digital Platform (PalmHub); second a singular ground-mounted Small Footprint High Rise (PeS-SFHR) Solar Energy Device or a collection of multiple Small Footprint High Rise (PeS-SFHR) Solar Energy Devices; and third, a Base Station (Electronic Cabinet) containing an Array Control Module (ACM) and an Energy Control Module (ECM). The entire system is designed and engineered to operate on the basis of a specified device serial number, thereby imparting to the site evaluation, energy analysis, system design, installation, activation, operation, optimization, management, and monitoring process a high level of efficiency, economy, and simplicity.

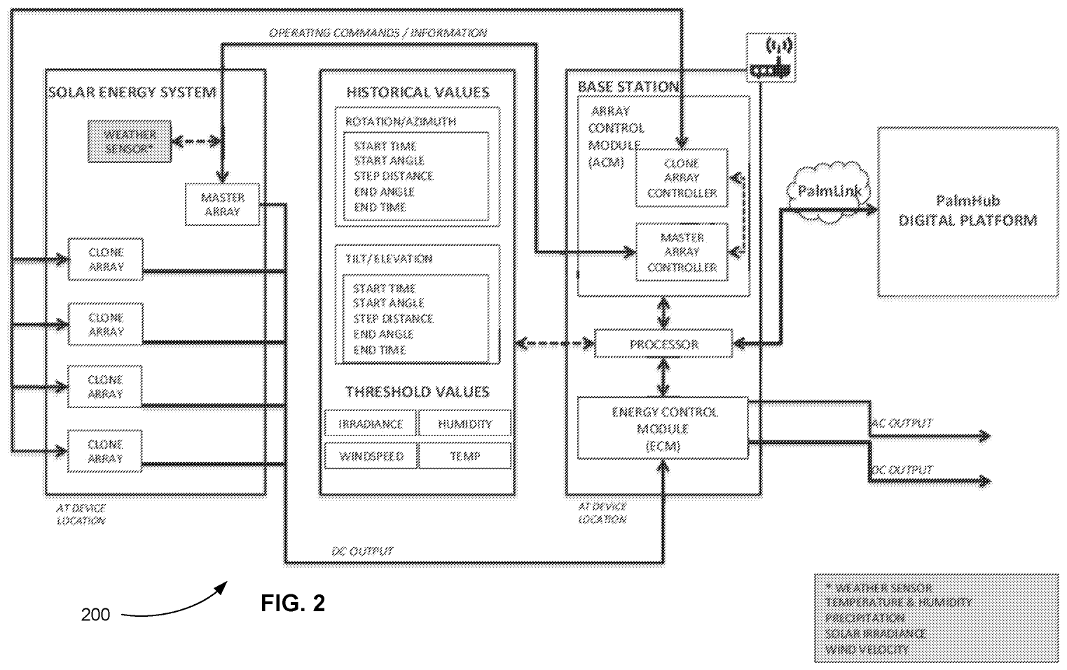

FIG. 2 is a block diagram 200 illustrating certain of the primary components, elements, and processes of the Array Control Module (ACM) that are used in an implementation of the inventive clean energy system, the Palm-e System (PeS), in accordance with various embodiments.

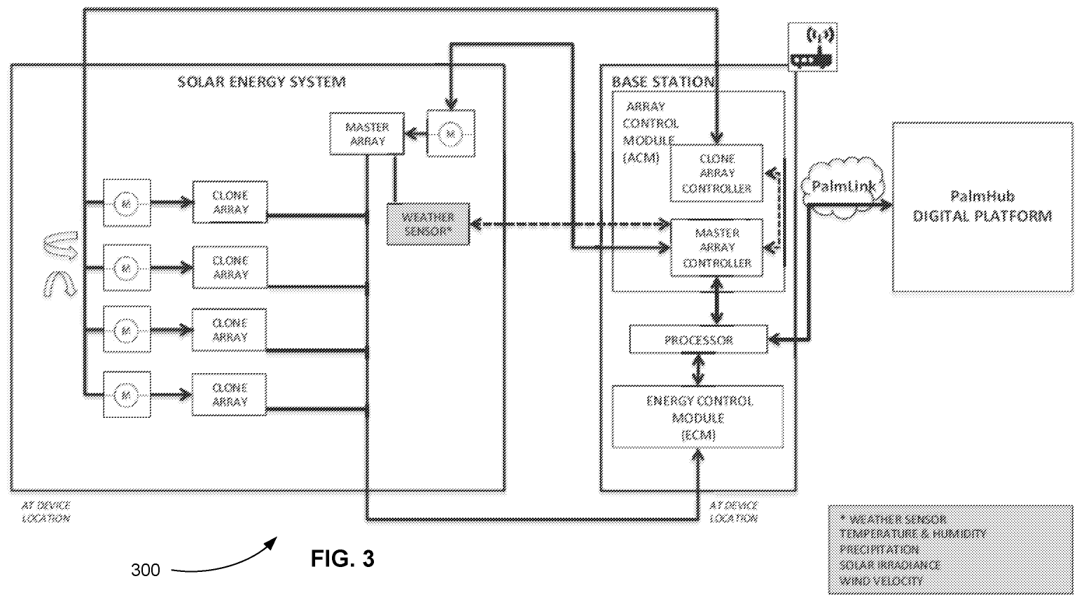

FIG. 3 is a block diagram 300 illustrating certain of the primary components, elements, and processes of the Solar Energy System that are used in an implementation of the inventive clean energy system, the Palm-e System (PeS), in accordance with various embodiments.

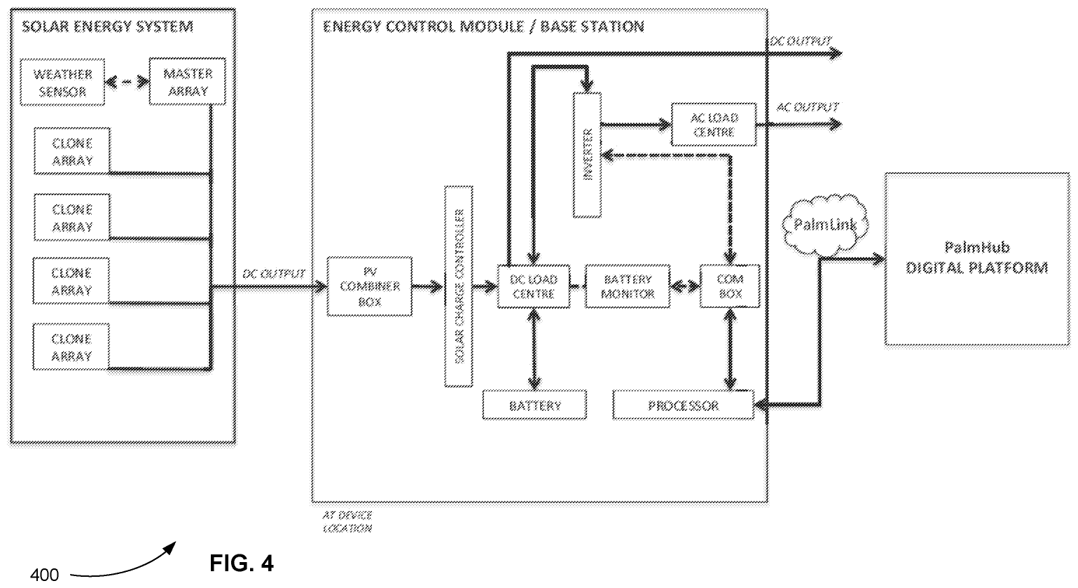

FIG. 4 is a block diagram 400 illustrating certain of the primary components, elements, and processes of the Energy Control Module (ECM) that are used in an implementation of the inventive clean energy system, the Palm-e System (PeS), in accordance with various embodiments.

### Component 1: Digital Platform (PalmHub)

Digital Platform (PalmHub) automated and semi-automated platform which, configures, controls and monitors the Palm-e SFHR solar energy device comprises of three interconnected components—first, a Device Configuration System (DCONS), second a Device Command System (DCS) and third an E-Commerce System (ECS). The three components are configured to operate independently, concurrently, simultaneously, and/or sequentially to execute a range of commands and/or issue a series of instructions based on a single primary input criteria—the GPS coordinates of the specified device/s/system. This input condition generates a device serial number (SN), which tags the device to PalmHub and serves as a “device signature” throughout its entire life cycle.

The Device Configuration System (DCONS) designs and configures the device/system and contains the device and System Database (SD), which is tagged to SN and comprises, system design data, site mapping data, and site geotechnical data.

The System Database (SD) links to external data stations through proprietary APIs to source data, correlate data in real-time with reference to benchmark/threshold data, and facilitate System Design. SD also interacts with DCS enabling it to execute operational commands to the device/system.

DCS comprises the SCADA and HMI command systems, which receive system data from SD, process commands, and transmits these to the base station. DCS also receives device/system performance data enabling system optimization, management, and monitoring through SCADA and HMI.

PalmHub is linked to all installed PeS SEHR devices through the base station, which is in real-time or intermittent communication with PalmHub through WIFI, 3g/4g/5g, LAN or Satellite communication depending on the location of the specific device/system, and the communication infrastructure available at the specified location.

PalmHub is programmed and equipped to analyze location feasibility, design device layouts, configure device installation, provide device operational control instructions, and monitor device performance on the basis of a serial number, which is tagged to the GPS coordinates of a specified device. As such it is designed and engineered to evaluate, analyze, design, install, control, operate, manage, and monitor the entire global network of PeS SFHR devices simultaneously and concurrently, forming a central control system operated remotely and insulated from a range of potential site specific outages. Over time, PalmHub is expected to exponentially increase its intelligence quotient through intelligent learning, ai, and IoT and offer higher levels of control, analysis, system efficiency, optimization, and productivity.

The base station (SeeD) located onsite in close proximity to the PeS SFHR device, is location specific and contains two interconnected control modules—first, a Device Control Module (DCM) and second, an Energy Control Module (ECM).

DCM executes a first set of commands comprising a range of fixed operational commands followed by a second set of commands comprising variable operational commands through device motors controlling the rotational movement of the solar array of a PeS SFHR device.

Fixed commands are based on stored historical device/system values pertaining to sun angle—Azimuth and Elevation. Commands may include but are not limited to rotation start time, start angle, step distance, end angle, and end time.

Variable commands are issued in the event that stored historical values vary with respect to current or expected values, breach threshold conditions, and require DCM to override fixed commands on account of device performance and/or safety criteria.

Current/expected values are transmitted to DCM either from DCS, in the case of a networked system, or, from onboard sensors in the case of autonomous non-networked systems.

A breach of threshold value requires the device to assume a pre-designated “safe-lock” position in case the following conditions are satisfied: If the light intensity is below a threshold value (performance criteria); If the wind velocity is above a threshold value (safety criteria); or If precipitation is above a threshold value (safety and performance criteria).

“Safe-lock” is defined here as a pre-designated alignment condition wherein device motors are switched off, the device array assumes a locked position and the device achieves a maximum factor of safety and optimum factor of performance simultaneously. In safe-lock, the device either performs as a fixed (non-rotational) device or instructs the solar corolla to assume a safe position with respect to prevailing adverse weather conditions, such as wind, rain, sleet, hail, or snow. For example, in case of snowfall, the solar corolla would assume a maximum vertical alignment to prevent accumulation of snow on the surface of the solar corolla during the non-daylight hours. Alternatively in a high wind gust condition, the solar corolla would assume an alignment that facilitates the least surface area to wind resistance.

ECM comprises the electronic hardware and equipment and controls, executes and monitors energy performance commands.

The device in turn sends back operational and performance-related data to ECM, which is processed by ECM and relayed to DCS for performance analytics, monitoring, and reporting.

The Base Station (SeeD) may control a singular PeS SEHR device or a collection (micro-gid) of multiple PeS SFHR devices, depending on system design and configuration.

### Component 2: Palm-e Small Footprint High Rise (PeS-SFHR) Solar Energy Device

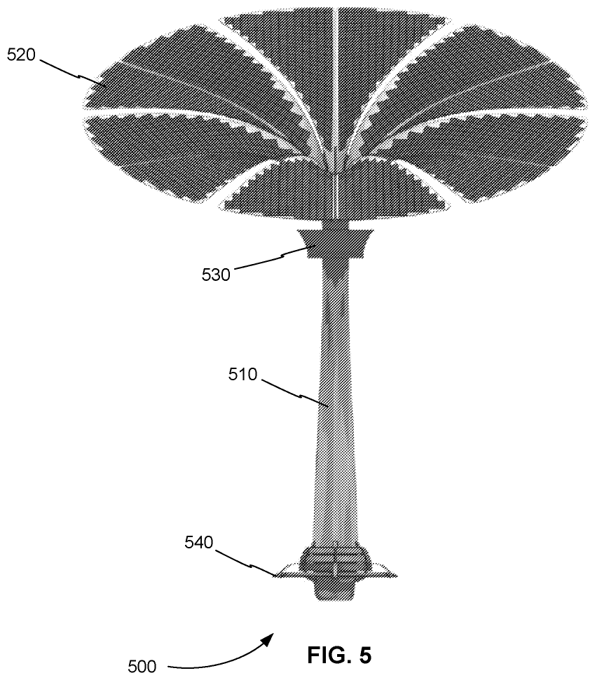

FIG. 5 is an exemplary diagram 500 of the Palm-e Small Footprint High Rise (PeS-SFHR) device, in accordance with various embodiments. The PeS-SFHR device is an efficient, integrated device comprising three components-a central pillar 510, a canopy (solar array) 520, and a fulcrum 530, which connects canopy (solar corolla) 520 to central pillar 510. Each device is attributed a serial number, which is linked to its specific locational GPS coordinates. The fulcrum of each device is also marked with magnetic North-South directional alignment markings, which along with its serial number, establishes the precise directional orientation of the device at the time of installation.

In various embodiments, the PeS-SFHR device further includes bench or seat 540 connected to central pillar 510. Bench 540 allows people to sit under the PeS-SEHR device and enjoy the shade provided by canopy 520.

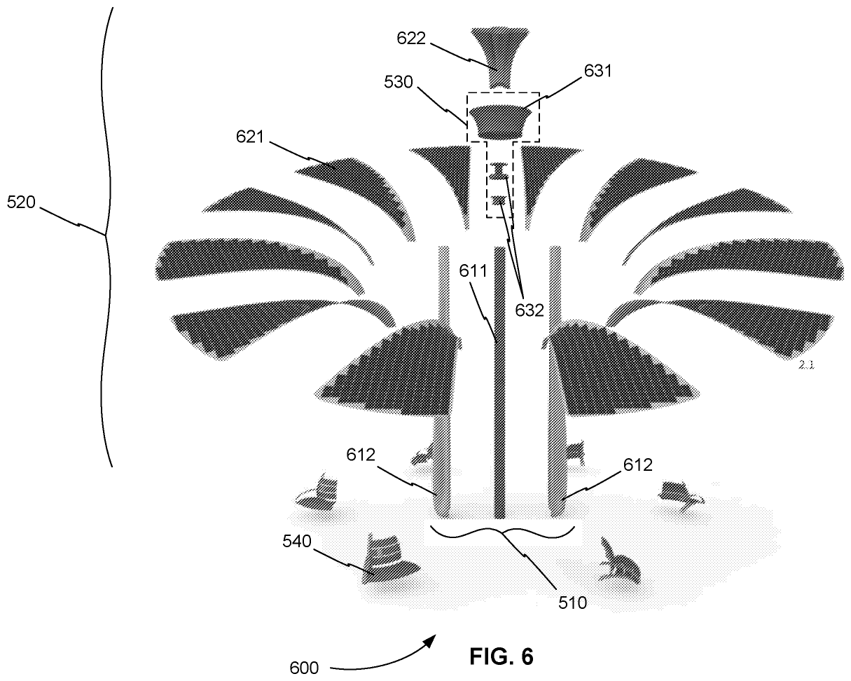

FIG. 6 is an exemplary diagram 600 showing an exploded view of the Palm-e Small Footprint High Rise (PeS-SFHR) device, in accordance with various embodiments. Central pillar 510 is double-layered. The inner layer consists of a vertical structural pole 611 of specified diameter, thickness, and length, which in some cases is gently tapered with a larger diameter at its base and a smaller diameter at its top and in other cases a uniformed cylindrical pole. The pole is anchored to a base plate (not shown), which in turn is anchored to the ground through the provision of a foundation, which may differ in its construction based on the soil characteristics of the proposed location of the device. The inner layer plays the role of the primary structural support of the device. Structural pole 611 is constructed out of carbon steel or other suitable high-strength materials, which conform to the structural requirements of the structural pole.

The outer layer of the central pillar 510 consists of a molded, textured lightweight cover piece 612 which is affixed to the structural pole with brackets or clasps and plays a non-structural and decorative role by serving as an aesthetic covering to the structural pole. The outer layer is constructed out of molded UPVC, fiberglass, or such similar lightweight durable external grade material. The cavity between the structural pole and the outer layer houses electrical and electronic components, which connect canopy (solar array) 520 to the Base Station (not shown).

In various alternative embodiments, pole 611 is a steel tube that can be cylindrical or conical and a plastic (ABS) or composite material (glass fiber+resin) sheath. Cover piece 612 can be attached to the pole by bolting, screwing, or riveting and serves an aesthetical purpose as well as providing an irregular and conical surface ensuring that vortices in the air caused by the wind around the pole do not infer resonant frequency oscillations to the pole. The power cables for the light and from PV array 520 to the electronic cabinet and the electric motors for the rotations systems are either contained inside pole 611 or placed between pole 611 and cover piece 612. Cover piece 612 can be painted or colored to offer advertising or communication purposes. Pole 611 can be welded or bolted to a steel plate (not shown) at the bottom. The plate contains holes for threaded steel bars and bolts. Pole 611 is attached to a base plate which is affixed to a concrete anchor poured in the ground, through four or more threaded bars, which are integrated into the base plate and protrude upwards to be aligned with the holes in the baseplate of pole 611.

In various embodiments, PeS-SFHR “solar corolla” (canopy or PV array) 520 includes two components: solar petals 621, a plurality of double or triple-curved solar energy generating large span membranes, and a joining piece 622. Each petal of plurality of solar petals 621 is arranged radially around a central point in a generally circular arrangement. Each of the solar petals is individually fixed to common central joining piece 622, which connects each petal of plurality of solar petals 621 to fulcrum 530.

Each petal of plurality of solar petals 621, in turn, is multi-layered in its construction and comprises three layers-first, an upper polymer-based transparent durable lightweight protective layer, second, a central layer consisting of an array of monocrystalline solar photovoltaic cells encapsulated in polymer film, and, third, a lower high strength structural layer cum back sheet formed out of carbon fiber composites. These three layers together form the double-curved composite solar petal of plurality of solar petals 621.

In various embodiments, plurality of solar petals 621 are made of individual curved multi-layer surfaces arranged radially and attached to the center of the arrangement. The surfaces are attached only to the center or also to each other along the adjoining edges or also at the tip of the adjoining edge or at several points along the edge. The central point of the array is where the dual-axis rotation system is located and the pole is directly below this rotation system. This dual-axis rotation system is also referred to as the fulcrum. The pole is fixed to the ground and anchored.

The sections of the PV arrays on individual surfaces are called “petals”. The petals are composed of a layer of PV cells sandwiched between a transparent layer on the top and a structural surface on the bottom. The structure of the bottom surface is itself multi-layered and is manufactured in various ways.

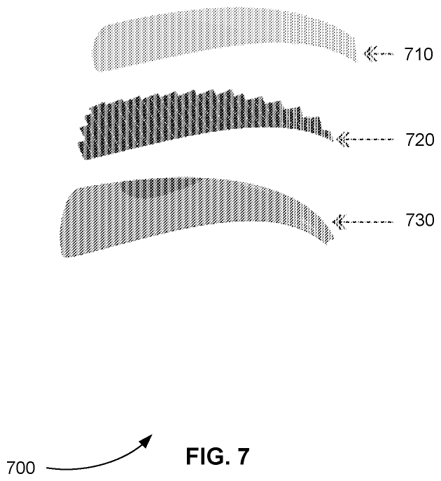

FIG. 7 is an exemplary diagram 700 showing three layers of a solar petal, in accordance with various embodiments. Upper layer 710 is a protective transparent plastic layer with dustproof coating. Upper layer 710 provides ultraviolet (UV) protection and water resistance. Central layer 720 includes high-efficiency monocrystalline photovoltaic cells. Lower layer 730 includes a carbon fiber surface with a three-dimensional curvature. Fiber weaving and thickness variation are used to achieve high rigidity. Lower layer 730 is fixed to fulcrum 530 of FIGS. 5-6 at the thinner end.

Upper layer 710 on the top can be made of one or a combination of several materials, such as but not limited to, Acrylic, High-Density Polyethylene (HDPE), Polycarbonate, Polyamide-Imide (PAI) or Polyvinylidene Fluoride (PVDF). The main characteristic of this layer is to provide transparency to the largest spectrum of sunlight while being UV-resistant, weatherproof, and scratch resistant. It can be shaped in three dimensions to conform to the curvature of the supporting layer. This layer can be coated with a dust repellent or manufactured in a manner that will repel dust. This layer can be glued, bolted, screwed, or clamped to the supporting surface. It may also be slid under a lip created in the supporting surface.

Central layer 720 can be mono-crystalline or polycrystalline silicon cells that are soldered together or attached using purpose-made clips from the cell manufacturer. Other types of PV cells can be used, such as thin film solar cells, Perovskite solar cells, multi-junction solar cells. The cells can be glued or clamped to the supporting surface. The electric current generated by the cells is collected by a pair of cables that are attached to the supporting surface. The cables terminate with an MC4 plug to allow connection to another set of cables running down inside the pole to the ground and onwards to the electronic cabinet.

Lower layer 730, the supporting surface, can be bi or tri-dimensionally curved and can be made as a single surface or as a three-dimensional object composed of several materials and several layers. If it is a single surface, it can be made of carbon fiber or glass fiber bonded with epoxy resin.

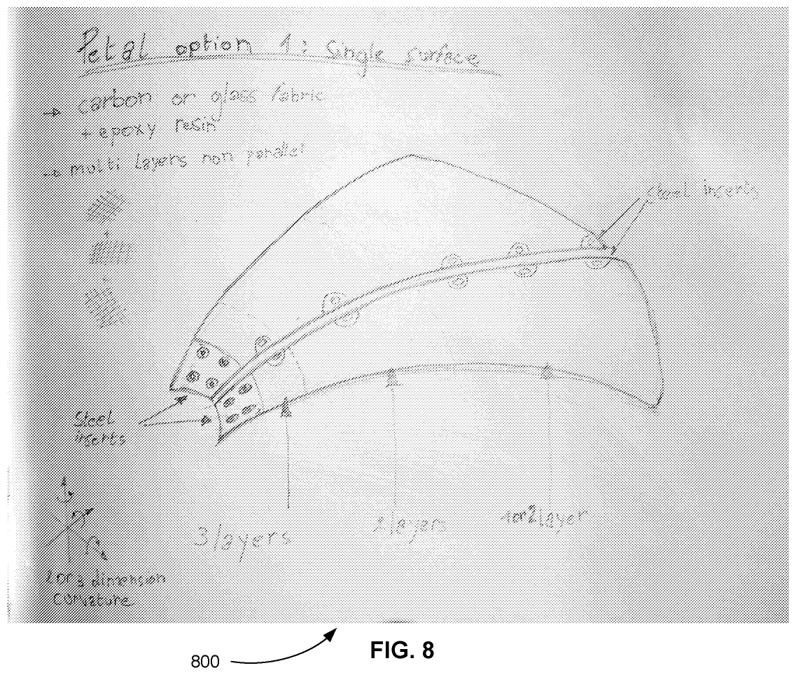

FIG. 8 is an exemplary diagram 800 showing a single surface supporting structure, in accordance with various embodiments. The surface can be curved in all two or three dimensions to provide stiffness. There can be several layers of the fiber on the whole surface with more layers on the narrow side of the surface, where it attaches to the rotation element. The directions of the fibers of each layer may not be parallel to offer stiffness in all directions. To attach to the fulcrum, a metal insert is integrated into the layers that facilitates bolting or clamping the surface to the fulcrum. Several other inserts might be used if the surfaces are also attached to each other.

In various embodiments, the surface may also be made as a three-dimensional multi-part object including two separate surfaces sandwiching a structural element.

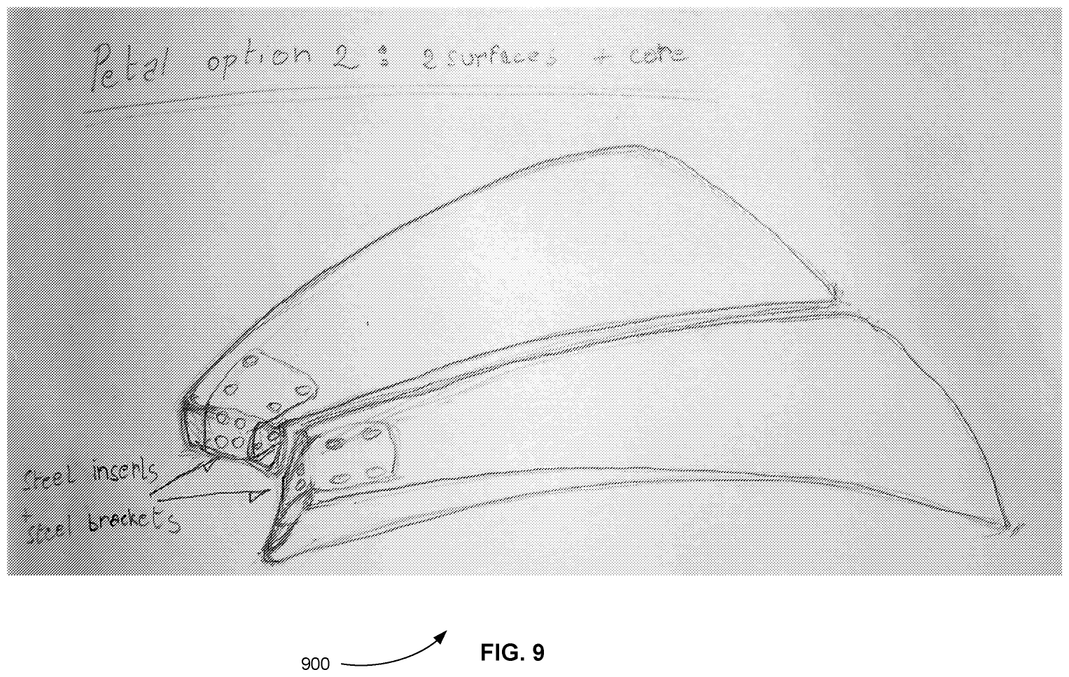

FIG. 9 is an exemplary perspective view 900 showing a three-dimensional supporting structure including two separate surfaces sandwiching a structural element, in accordance with various embodiments.

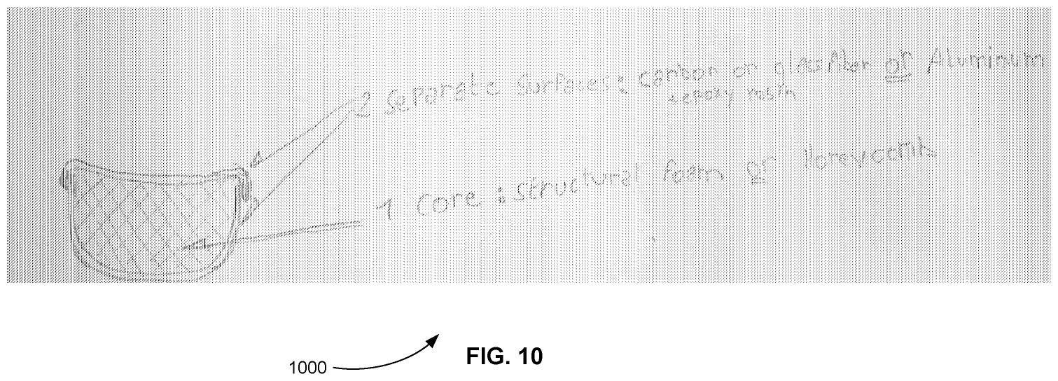

FIG. 10 is an exemplary cross-section view 1000 showing a three-dimensional supporting structure including two separate surfaces sandwiching a structural element, in accordance with various embodiments. The two surfaces can be made of either carbon fiber or glass fiber with epoxy or metal sheets (aluminum) or plastic sheets (high-density polyethylene (HDPE)). Both surfaces may also be curved in two or three dimensions. The sandwiched structural element can be made out of structural foam or a honeycomb structure made of lightweight plastic or metal or paper.

In various embodiments, the structural element may also comprise a set of multiple cross-sections arranged parallel to each other and made of aluminum, steel, plastic, or wood.

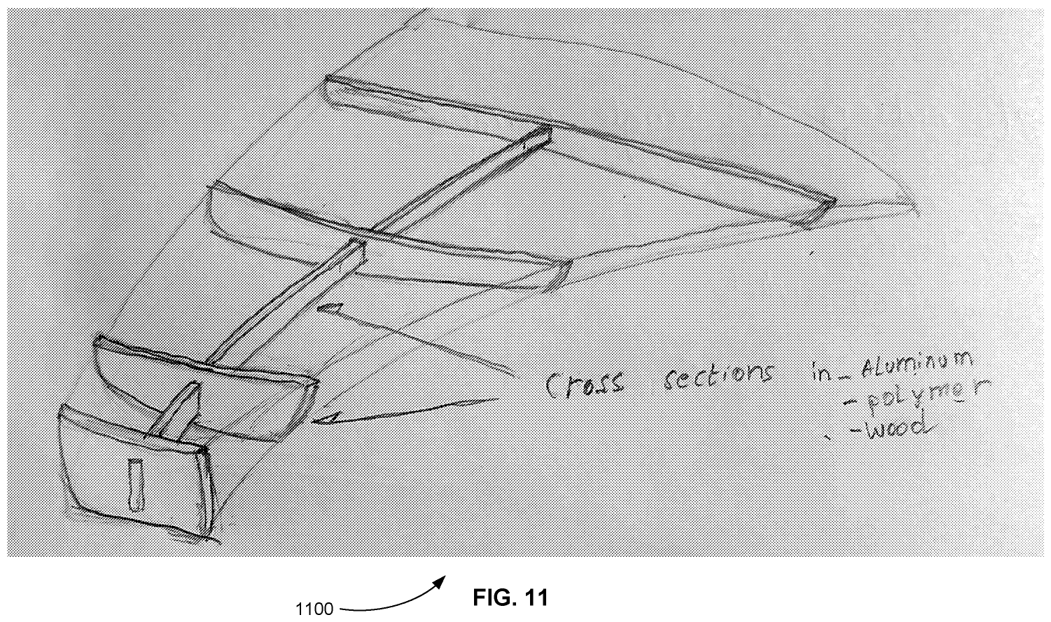

FIG. 11 is an exemplary diagram 1100 showing a structural element that includes a set of multiple cross-sections arranged parallel to each other and made of aluminum or steel or plastic or wood, in accordance with various embodiments.

In various embodiments, the required structural strength may also be attained through a network of metal tubes (steel, aluminum, or composite) welded to each other to form a skeleton-like frame structure between the two surfaces. This metal frame structure can be either entirely contained between the two surfaces or be visible from the outside.

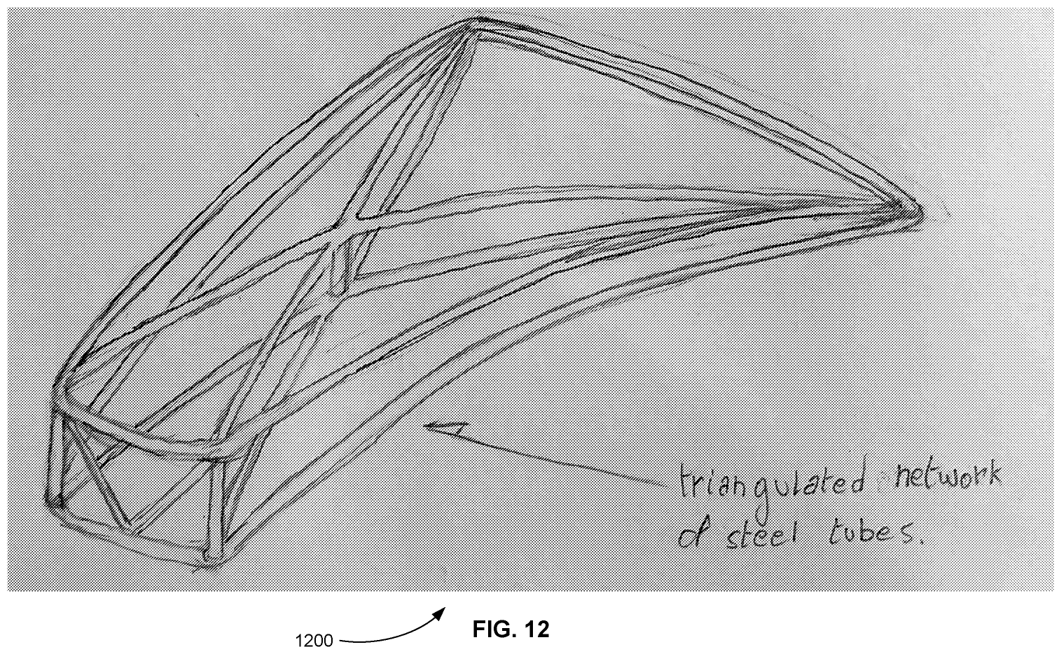

FIG. 12 is an exemplary diagram 1200 showing a structural element that includes a triangulated network of metal tubes (steel or aluminum or composites) welded to each other to form a skeleton-like frame structure between the two surfaces, in accordance with various embodiments.

In various embodiments, the two surfaces are attached to the structural element by gluing, bolting, screwing, or riveting. Inserts can be used for this purpose in both the structural element and the surfaces. The whole three-dimensional object can be attached to the fulcrum by means of bolts or clamps. Use of rubber or other compliant materials or springs can be made between the petal and the fulcrum with the purpose of dampening the vibrations and movements of the petal, thus preventing movements of the petal from generating resonant vibration in the fulcrum, the pole, and the adjoining petals.

For redundancy, PeS-SFHR Solar Petals are swappable and can be upgraded during the lifespan of the device. Considering the pace of technological advancements in solar PV cell performance and efficiency, swappable solar petals would keep PeS technologically relevant.

Returning to FIG. 6, central joining piece 622 performs the transitional role of accepting the complex geometrical form of solar petals 621 and transforming it, along its length, into a simpler cylindrical geometrical form, which is then joined to fulcrum 530. The shape and design of central joining piece 622 also impart to canopy (solar array) 520 a specified angle of inclination with respect to the vertical axis, which is determined by the optimum zenith angle and maximizes the incidence of solar radiation onto canopy (solar array) 520. Central joining piece 622 houses a daylight sensor and a rain sensor at its center. The sensors have no influence on the operation of the PeS-SFHR device. They specifically communicate real-time data to the Energy Control Module (ECM) and the DCM to monitor energy performance, predict energy performance in view of current daylight and precipitation scenarios and inform and align and optimize the intelligent Net Energy Metering (NEM) system with the grid.

In various embodiments, fulcrum 530 is one of the two following types-a fixed fulcrum or a sun-tracking fulcrum.

In various embodiments, a fixed fulcrum is fitted to the upper end of pole 611 and to the lower end of central joining piece 622. It is designed and engineered to facilitate a manually operated rotational movement of the fulcrum with respect to structural pole 611, at the time of device installation, to select and fix an optimum position of canopy 520 with respect to the diurnal movement of the sun along the horizontal plane.

The fulcrum is designed and engineered to facilitate a manually operated pivotal movement to canopy 520 to fix an optimum vertical tilt alignment with respect to the optimum annual alignment of the sun. Once the optimum horizontal and vertical alignments have been obtained and fixed at the time of installation, the device operates as a fixed PeS-SFHR solar energy device with no operational moving parts.

Sun tracking increases the efficiency of a solar array up to 30%-40% by facilitating a reorienting solar array, which at all times during the sun's path across the sky, ensures that the solar array is aligned perpendicular to the angle of incidence of the sun.

In various embodiments, the PeS-SFHR sun-tracking fulcrum facilitates horizontal rotational movement about the structural pole and a pivotal vertical movement of the canopy during the operational period and lifespan of the device. Rotational and pivotal movement is implemented through a combination of bearings, gears, axels, levers, and a set of motors, which generate specified pulses of energy, when required, to rotate and pivot canopy 520 to the optimum sun angle required at a specified time of the day.

The fulcrum is composed of a vertical axis rotation system, and horizontal axis rotation system, a fixation system to attach it to the petals, and a lighting system. The whole is covered by a plastic or metal molded element that makes the visual transition between the petal and the pole. This element will move with the petals. This element is attached by bolting or riveting to the fulcrum on the part that is fixed to the petals.

The vertical axis rotation system has its axis aligned with the pole. Both rotation movements can be performed similarly to the waist and shoulder of an industrial robotic arm. Variations of the types of different articulations possible are described below in reference to different types of axis rotation systems.

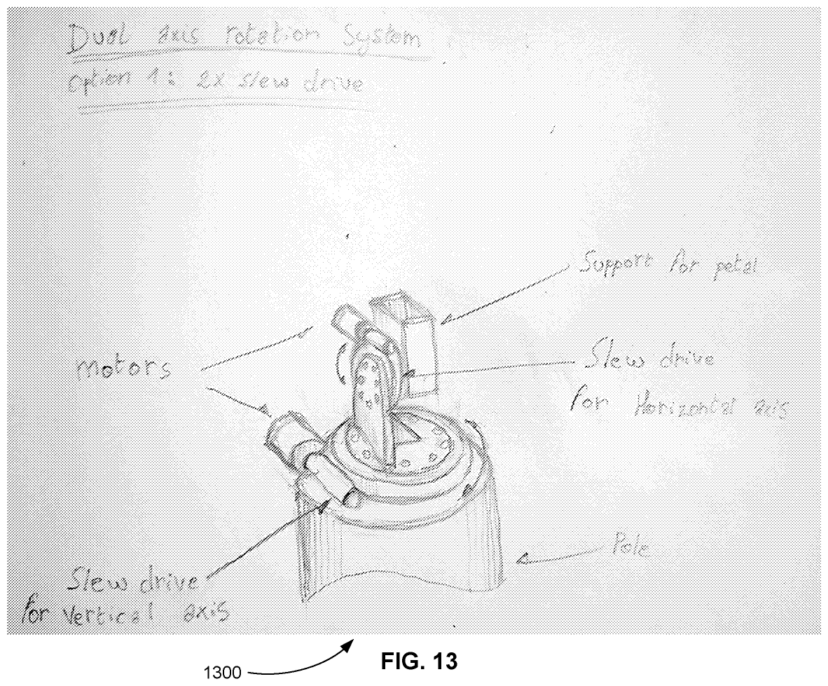

FIG. 13 is an exemplary diagram 1300 of an axis rotation system where both vertical and horizontal axis rotations are done by means of slewing drives, in accordance with various embodiments. One slew drive is attached to the pole with the axis of rotation vertical. The other side of the slew drive is bolted to a steel plate forming the fulcrum. On this plate, flanges are affixed to support a second slew drive with its axis of rotation being horizontal. The other side of this second drive is affixed to another steel plate that will support the fixtures to the petals. For both of the slew drives, the axles can be supported by an additional set of ball or roller bearings. The slew drive offers the possibility to serve as a brake as well.

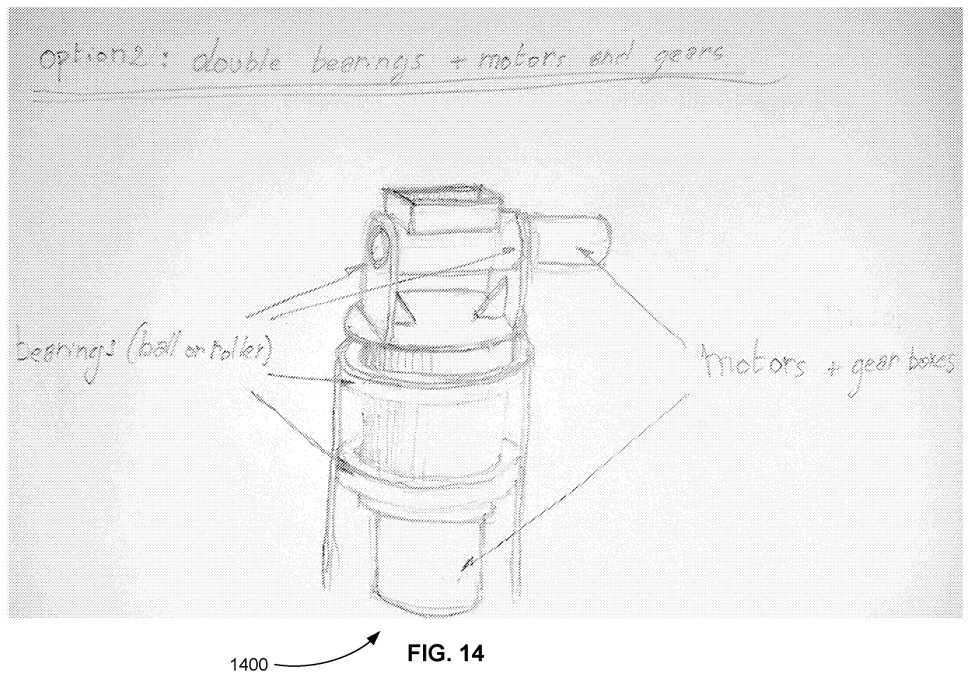

FIG. 14 is an exemplary diagram 1400 of an axis rotation system where the vertical axis rotation is undertaken using two double or single ball or roller bearings between the pole and a smaller steel rod or tube, in accordance with various embodiments. The bearings are separated by a distance similar to the larger diameter of the bearings. The smaller steel tube is welded to a steel plate that is supporting the horizontal axis articulation. This arrangement is similar to the articulations on an articulating jib crane or a robotic arm. The horizontal axis articulation is made identically but with its axis placed horizontally. The rotation of both elements can be powered by two separate electric motors (stepper or servo or hybrid): one for each axis. The vertical axis motor is inserted inside the pole, below the rotation system, or inside it. It can also be situated outside the pole. It is fixed to the pole and powers the rotation by means of gears interfacing with the second tube or rod fixed to the fulcrum. For the horizontal axis rotation, the motor is fixed to the fulcrum and interfaces with the element that attaches to the petals by means of gears.

In various embodiments, another way that the vertical axis articulation can be undertaken is with three or more pairs of steel wheels similar to train wheels with the flange on the outside arranged radially across the pole, linked by an axle and interfacing between a horizontal plate welded to the pole and another plate fixed to the fulcrum element. The alignment of both plates is ensured by circular tracks in the plates and flanges on the wheels or a cylindrical casing around the top plate (attached to the fulcrum). This alignment can also be made by having the wheel axis not horizontal, arranged radially in a cone-like structure.

In various embodiments, another way that this rotation can be made possible is with the use of three or more conical steel rods arranged radially inside tracks. This ensures both the rotation and the alignment of the two elements. The axis of the cones is horizontal. The rotation of the two elements is powered by an electric motor (can be a stepper motor, servo motor, or hybrid). The motor is fixed to the pole and interfaces with the fulcrum by means of steel gears.

In all possible arrangements, impulses are given periodically by the motors to move the fulcrum by one or several degrees every minute or every few minutes.

Instead of gears for all rotations, the motions could be powered with the use of a ratchet being pushed in contact with the fulcrum at regular intervals and generating the motion. The ratchet arm is powered by an electric motor.

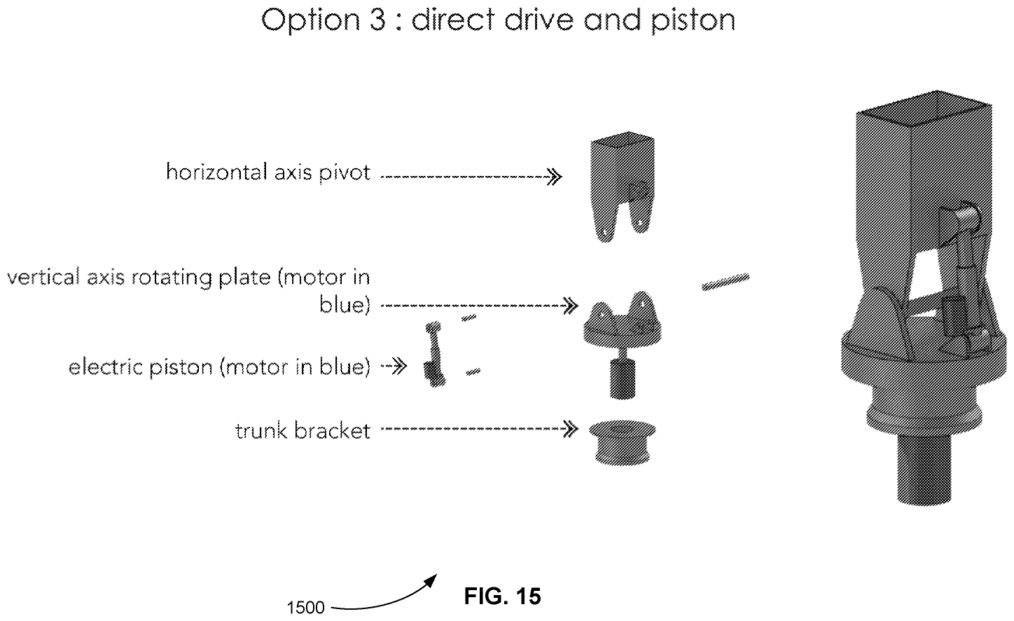

FIG. 15 is an exemplary diagram 1500 of an axis rotation system where the horizontal axis rotation occurs in the fulcrum between the element attaching to the petal and the element attaching to the vertical axis system, in accordance with various embodiments. A horizontal steel axle is fixed to the vertical axis rotation element and interfaces with the element attaching to the petals by means of two bearings (double or single ball or roller or conical). The motion is powered by hydraulic or mechanical screw pistons. One or more pistons are used to ensure redundancy and sufficient support. One end of the piston is fixed to the element attached to the petals and the other end is fixed to the vertical axis rotation element. In the case of the use of hydraulic pistons, an electric pump provides the necessary power. The electric pump is attached to the vertical axis rotation element. In the case of mechanical screw-type pistons, the power is provided directly by an electric motor. In this case, the electric motor is fixed to the pistons themselves.

In various embodiments, another way that the horizontal axis movement can be undertaken is through the use of gears or a ratchet system, similar to the vertical axis system but arranged horizontally. For this to function correctly and support the load of the petals, the rotating axle might be a large steel tube and could contain the motor and gears/ratchet.

In various embodiments, power for the motors for both vertical and horizontal movements is provided by the battery storage situated in the electronic cabinet or the AC grid connected to the device. It is not provided directly by the PV array. This ensures the possibility to power the rotation at all times and is independent of power generated by the solar array.

In various embodiments, the fulcrum also contains irradiation, wind, humidity, and temperature sensors to serve as a miniature weather station. The purpose of the sensors is to provide data that is used in the prediction of power production but they also alert the system of adverse weather conditions that will trigger the safe mode of the devices and lock the dual-axis rotation systems in the safe position. The sensors may also be integrated into the electronic cabinet instead of into the solar devices.

Returning to FIG. 6, in various embodiments, fulcrum 530 includes a ring housing 631 that conceals vertical rotation elements 632.

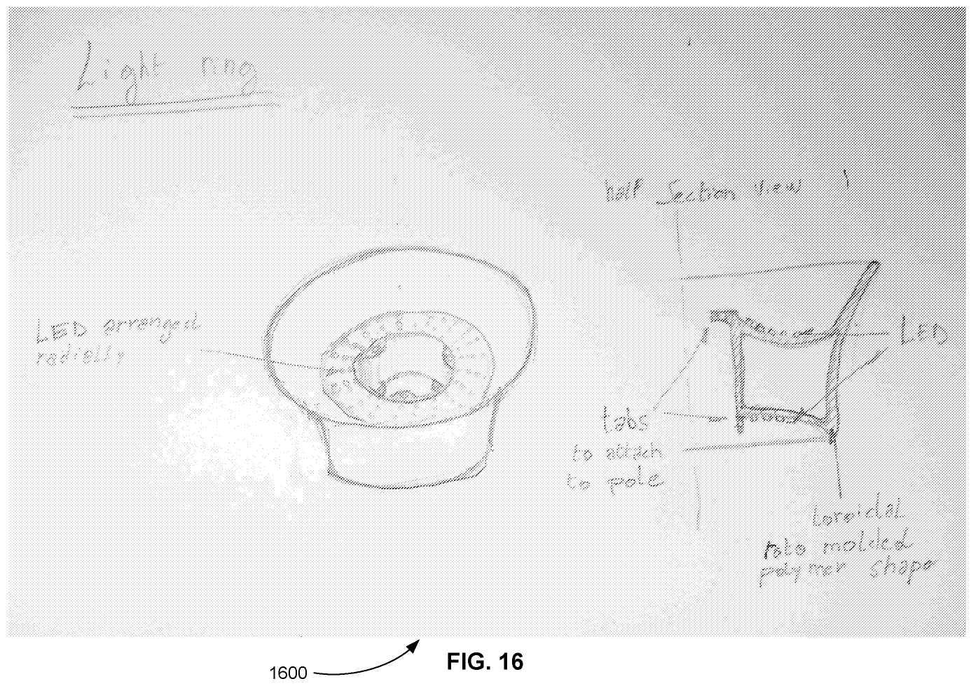

FIG. 16 is an exemplary diagram 1600 showing perspective and cross-sectional views of a ring housing of a fulcrum, in accordance with various embodiments. The ring housing is of a toroidal shape situated around the top of the pole and conceals the vertical axis rotation element. This ring is made of ABS plastic or composite material (glass fiber+resin) and fixed to the steel pole. The section of the ring presents two curves at both the top and bottom. In various embodiments the ring housing includes a top ring of light-emitting diodes (LED) lights aimed toward the top and a bottom ring of LED lights aimed toward the bottom of the device. The two rings of LEDs can be turned on independently and dimmed. Their color can be adjustable or pure white. Their light is reflected on the bottom surface of the petals to provide indirect lighting around the whole device and also along the pole to provide lighting directly below the device. The top ring of LED can be an interrupted ring to ensure that no light is pointing directly at the sky without being intercepted by the petals, in case the petal's edges are not touching.

The SEHR device communicates with the Array Control Module (ACM) and the Energy Control Module (ECM).

### Component 3: Base Unit (SeeD).

The SeeD is a weatherproof; secure modular unit located in proximity to the PeS-SFHR device or a network of multiple SFHR devices. It contains a collection of power electronics, an onboard computer, and microcontrollers, more specifically defined as the Array Control Module (ACM) and the Energy Control Module (ECM). ACM controls the mechanical operation of the device, while ECM controls the electrical operation of the device. ECM receives DC electrical power output generated by the solar petals of a PeS-SFHR device and processes and converts this into AC electrical power for onward distribution to users. The ECM contains electronic equipment such as a PV combiner box, solar charge controllers, DC load center, inverters, batteries, battery monitor, AC load center, and a communication box (COMM Box). The ECM may support a single Pes-SFHR device or multiple Pes-SFHR devices depending on network configuration. It may further support a single autonomous battery-supported device, multiple networked autonomous battery-supported devices, a single grid-tie device, or multiple networked grid-tie devices depending on network configuration and User Requirements. The ECM is designed and engineered as a modular, expandable module, which can be configured to suit differing network configurations and situations.

The ECM sends device-related performance data to the EMS on the onboard computer, which in turn processes the data and relays it to the central server (DCS) to enable performance analytics, optimization, and reporting.

The electronics cabinet is called the “seed” and is situated in the vicinity of the solar device. One cabinet can be connected to one or several solar devices. The cabinet is made of steel or aluminum sheets for the top, back, and sides. It is placed on a concrete base and bolted to it. Slits are made in some of the panels to provide ventilation but are made in a way that prevents rainwater from entering. Alternatively, a downward curved pipe might be added on the concrete base with tubing inside the concrete connecting to the inside of the cabinet and including fans to provide sufficient ventilation. The sides of the cabinet can be integrating advertisement panels that are composed of a safety glass sheet and a steel or aluminum box with LED lighting. The glass panel is hinged and can be opened to replace the poster fixed inside.

The sides of the cabinet can also contain an LCD or a LED text display to display the production of power by the system or the use of power by EV chargers or advertisements or communication about the site. The front or back or both can be containing a user interface element. This element is a touch screen or screen +keyboard interface with a credit/debit card reader to allow the user to start a charge of an electric vehicle. The panel will also have one or two plugs to connect a charging cable for EV cars or have integrated cables with standard EV charging plugs (according to the market where it is installed). The cables can be fixed with slots to accommodate the plug when not in use or retractable, with the plugs protruding from the cabinet when retracted.

The cabinet includes several electronic devices according to the scenario of the use of the solar device.

If the device is off-grid and serves for EV charging only, it will contain Lithium-ion batteries, a charge controller for the battery, an EV charger, and an onboard computer controlling the vertical and horizontal axis rotations of the PV array and the user interface. The computer also controls the lighting of the device.

If the device is on-grid with no power backup, the seed will contain a DC to AC solar inverter, an onboard computer controlling the vertical and horizontal axis rotations of the PV array and the user interface. The computer will also control the lighting of the device.

If the device is on-grid with no power backup and EV charging, the seed will contain a DC to AC solar inverter, an EV charger powered from AC, and an onboard computer controlling the vertical and horizontal axis rotations of the PV array and the user interface. The computer will also control the lighting of the device.

If the device is on-grid with power backup and EV charging, the seed will contain a lithium-ion battery, a charge controller for the battery, an automatic transfer switch, a DC to AC solar inverter, an EV charger powered from AC, an onboard computer controlling the vertical and horizontal axis rotations of the PV array and the user interface. The computer will also control the lighting of the device.

The power rating of the Solar inverter, batteries, and EV chargers will depend on the number of solar devices connected and the number of cars to be charged every day. The solar inverter should have at least one Maximum Power Point (Mpp) tracker for each solar device to ensure the continuous operation of the system in the case of failure of one solar device. The cabinet also contains a local and external communication system. The local communication system can be wired or wireless and is used for bi-directional communication between the solar devices and the central computer. Data from the sensors is sent to the central computing system in the seed. Instructions and feedback to and from the motors controlling the dual-axis rotation are transmitted to and from the central computer in the seed.

The external communication is wireless or wired and is used to communicate to and from the cloud portal. Data regarding the production and use of power is sent to the cloud portal as well as the status of all devices. Instructions for the rotation system and the power management systems and their feedback is sent and received to and from the cloud portal.

### Installation and Operation of PeS

The installation and operations procedure of PeS removes many of the complexities currently associated with the installation of conventional solar energy systems and consequently reduces the proportionately high Balance of Services (BOS) costs associated with rooftop and utility solar panel installation. It also reduces installation time.

First, owing to the PeS SEHR device being an integrated device, the number of agencies involved with supply, transport, logistics, installation and commissioning is limited to one entity. This eases coordination, logistics and installation procedures. Secondly, owing to its small footprint, interventions to the existing urban habitat are limited to a small radius of influence. Thirdly, installation is a simple three-step process-first aligning the base of the central shaft to a North-South direction, second fixing in place the device components—fulcrum (North-South alignment), canopy, outer layer and connecting the device to the Energy Command System (ECS), and third switching on the on-board computer to connect the system to the Device Command System (DCS) and initiate device configuration, operation, and monitoring.

Typically, the process would commence with an in-depth analysis of the proposed location of the PeS SFHR device or network of PeS SEHR devices by the central server. This task is accomplished by creating layers of interrelated information and data such as topographic maps, satellite maps, shadow maps, urban habitat layout maps, built-form maps, transportation system maps, meteorological data, geological data, and weather data. Once these layers are created, the overlay map and data are analyzed and the most efficient device location points, device configuration, and network configuration are determined.

The obtained configuration settings and database are then assigned a specified serial number, which is linked to the GPS coordinates of a specified device. The serial number is then allocated to a device, which when activated, draws its configuration and operational settings from the central server.

### Solar Panel Apparatus

Returning to FIG. 5, a solar panel apparatus includes a central pole 510, a sun-tracking fulcrum 520, and a plurality of solar panel petals 520. Sun-tracking fulcrum 520 is connected to central pole 510. Plurality of solar panel petals 520 is connected to sun-tracking fulcrum 520. Sun-tracking fulcrum 520 both rotates and tilts the plurality of solar panel petals with respect to a location of the sun.

In various embodiments, each petal of plurality of solar panel petals 520 is an isosceles trapezoid that is curved from the shorter base to the longer base and is connected to fulcrum 530 at the shorter base.

In various embodiments, each petal of plurality of solar panel petals 520 can be flexible, semi-rigid, or rigid.

In various embodiments, each petal of plurality of solar panel petals 520 includes a top transparent and protective layer, a central solar photovoltaic layer, and a lower structural layer.

In various embodiments, the lower structural layer is a single surface.

In various embodiments, the lower structural layer includes two surfaces sandwiching a structural element.

In various embodiments, the structural element includes a set of multiple cross-sections arranged parallel to each other.

In various embodiments, the structural element includes a network of metal tubes welded together.

In various embodiments, plurality of solar panel petals 520 is connected to fulcrum 530 through a central joining piece.

In various embodiments, fulcrum 530 includes an axis rotation system where both vertical and horizontal axis rotations are done by means of slewing drives.

In various embodiments, fulcrum 530 includes an axis rotation system where vertical axis rotation is undertaken using two double or single ball or roller bearings.

In various embodiments, fulcrum 530 includes an axis rotation system where horizontal axis rotation occurs in fulcrum 530 between an element connecting to a petal of plurality of solar panel petals 520 and an element connecting to a vertical axis system.

In various embodiments, fulcrum 530 includes a ring housing that encloses the axis rotation system.

In various embodiments, the ring housing includes a top ring of lights to illuminate the bottom of plurality of solar panel petals 520.

In various embodiments, thee ring housing includes a bottom ring of lights to illuminate central pole 510.

### Method for Assembling a Solar Panel Apparatus

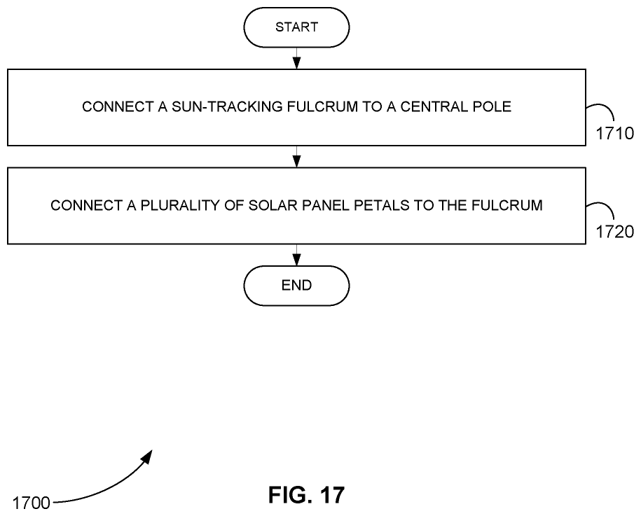

FIG. 17 is a flowchart showing a method 1700 for assembling a solar panel apparatus, in accordance with various embodiments.

In step 1710 of method 1700, a sun-tracking fulcrum is connected to a central pole.

In step 1720, a plurality of solar panel petals is connected to the fulcrum. The fulcrum both rotates and tilts the plurality of solar panel pedals with respect to a location of the sun.

### Additional Embodiments

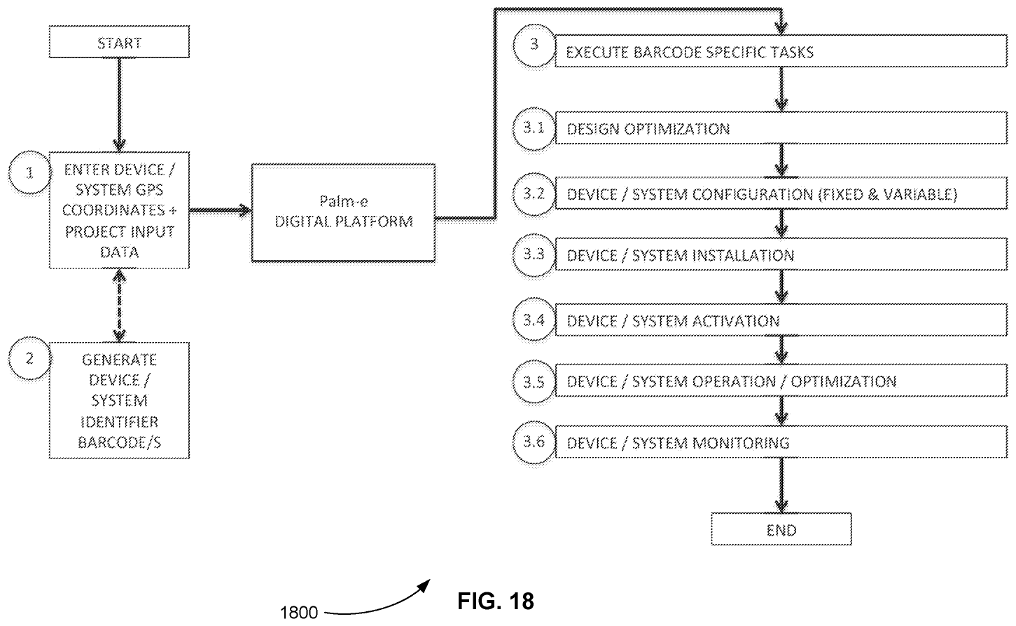

FIG. 18 is a master flowchart 1800 or flow diagram illustrating a process, method, operation, or function to determine the various sequential steps to “execute barcode specific tasks” that may be used in an implementation of an embodiment of the inventive clean energy system, the Palm-e System (PeS).

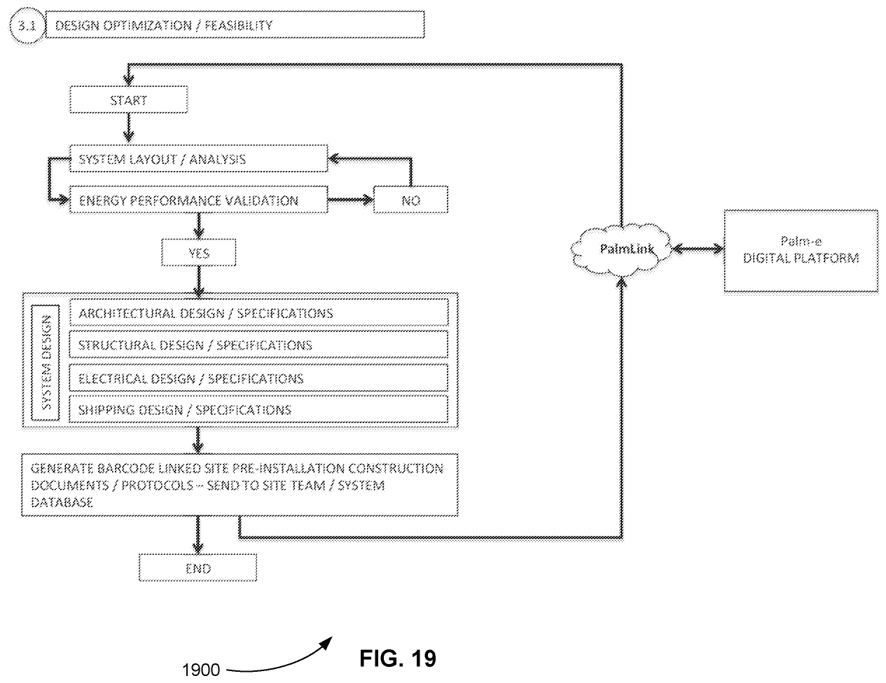

FIG. 19 is a flowchart 1900 or flow diagram illustrating a process, method, operation or function to determine “design optimization/feasibility” of a specific clean energy system that may be used in an implementation of an embodiment of the inventive clean energy system, the Palm-e System (PeS).

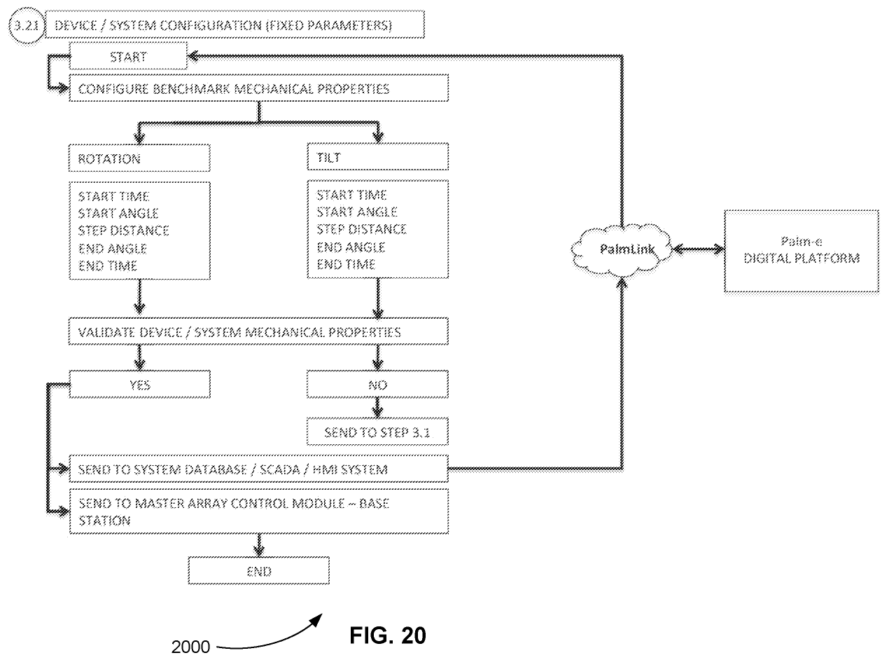

FIG. 20 is a flow chart 2000 or flow diagram illustrating a process, method, operation or function to determine “device/system configuration-fixed parameters” of a specific clean energy system that may be used in an implementation of an embodiment of the inventive clean energy system, the Palm-e System (PeS).

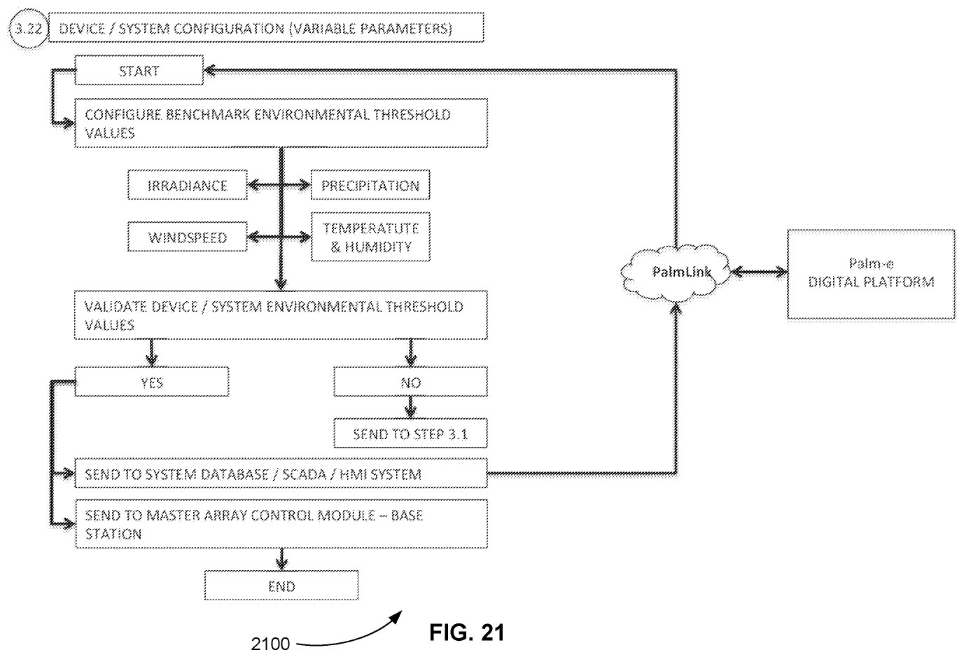

FIG. 21 is a flowchart 2100 or flow diagram illustrating a process, method, operation or function to determine “device/system configuration-variable parameters” of a specific clean energy system that may be used in an implementation of an embodiment of the inventive clean energy system, the Palm-e System (PeS).

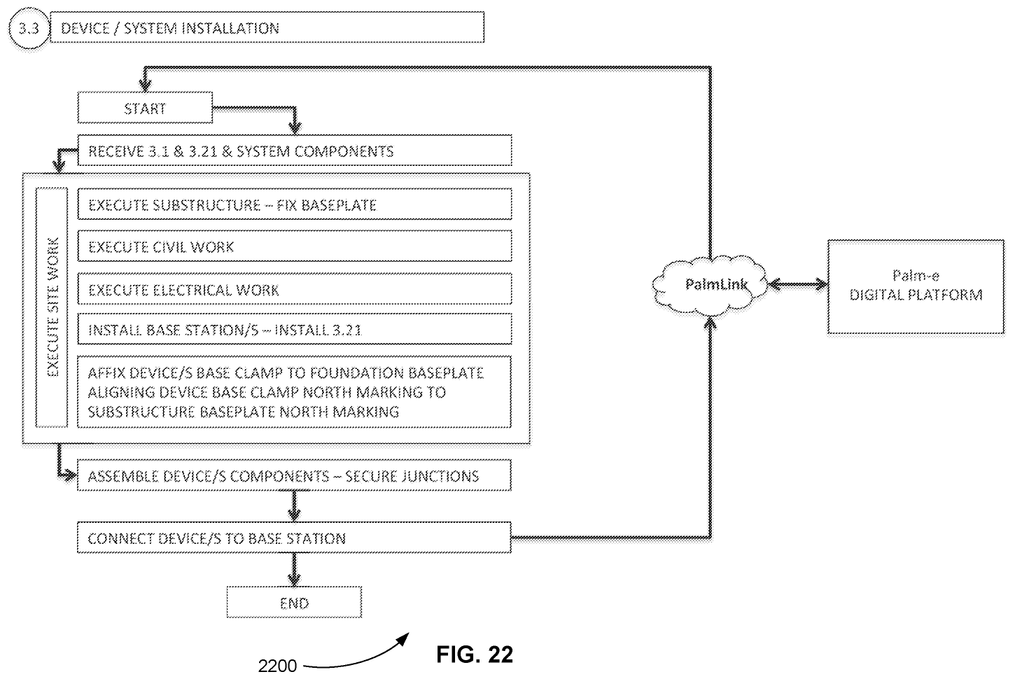

FIG. 22 is a flowchart 2200 or flow diagram illustrating a process, method, operation or function to determine “device/system installation” of a specific clean energy system that may be used in an implementation of an embodiment of the inventive clean energy system, the Palm-e System (PeS).

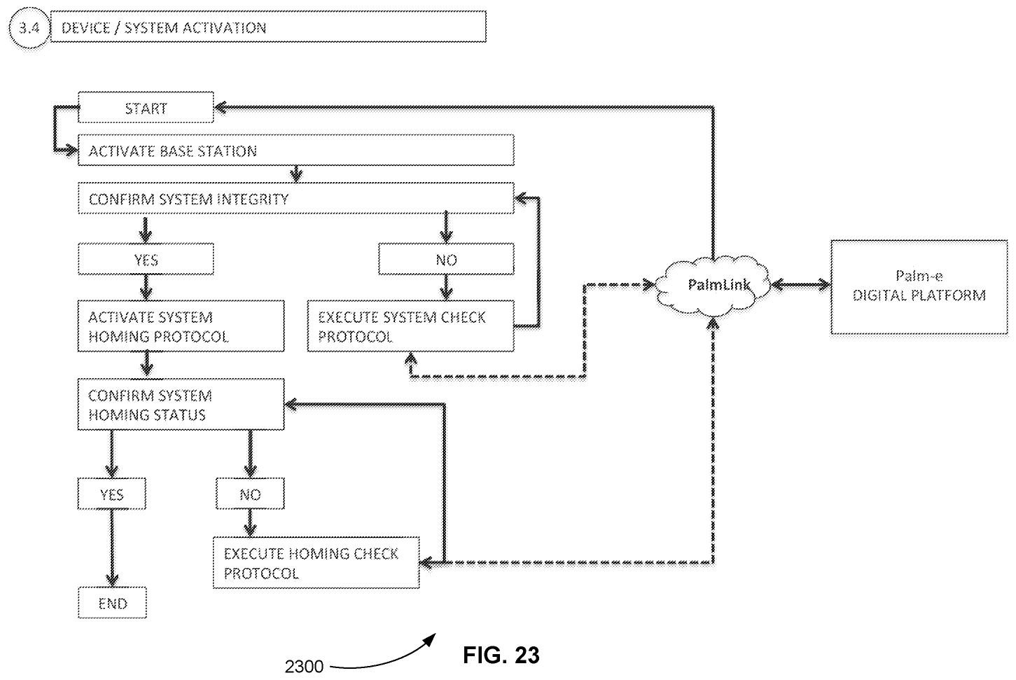

FIG. 23 is a flowchart 2300 or flow diagram illustrating a process, method, operation or function to determine “device/system activation” of a specific clean energy system that may be used in an implementation of an embodiment of the inventive clean energy system, the Palm-e System (PeS) 1000.

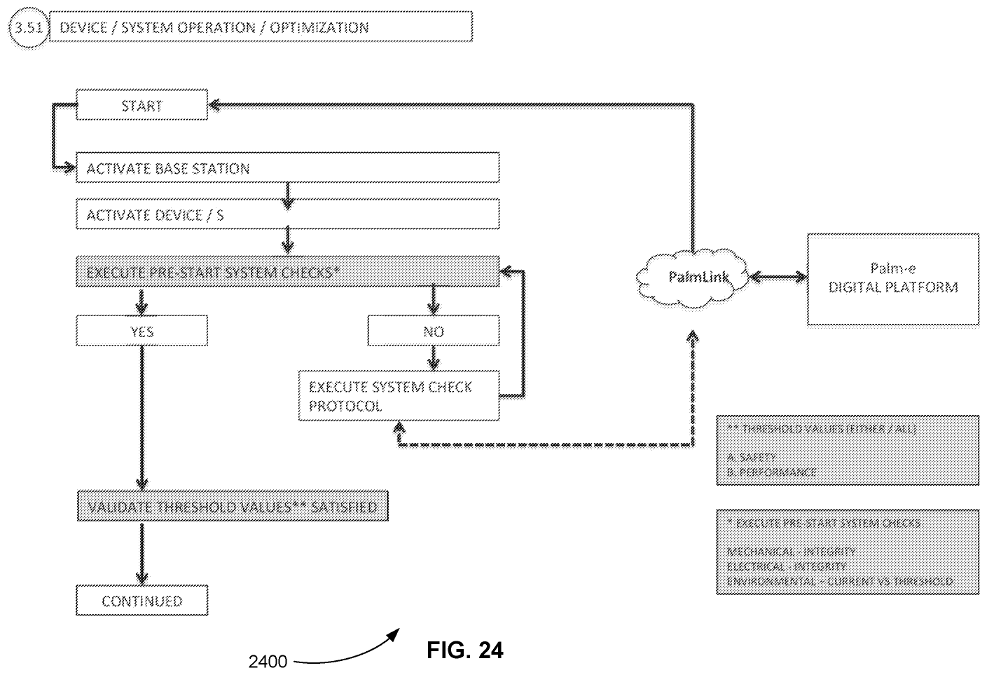

FIG. 24 is a first flowchart 2400 or flow diagram illustrating a process, method, operation or function to determine “device/system operation and optimization” of a specific clean energy system that may be used in an implementation of an embodiment of the inventive clean energy system, the Palm-e System (PeS).

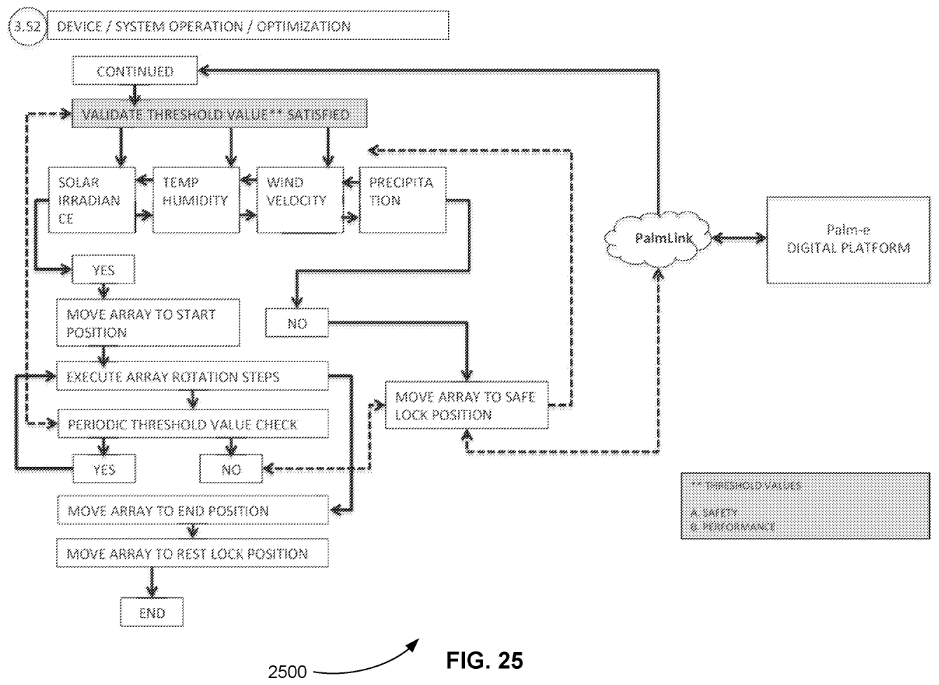

FIG. 25 is a second flowchart 2500 or flow diagram illustrating a process, method, operation or function to determine “device/system operation and optimization” of a specific clean energy system that may be used in an implementation of an embodiment of the inventive clean energy system, the Palm-e System (PeS).

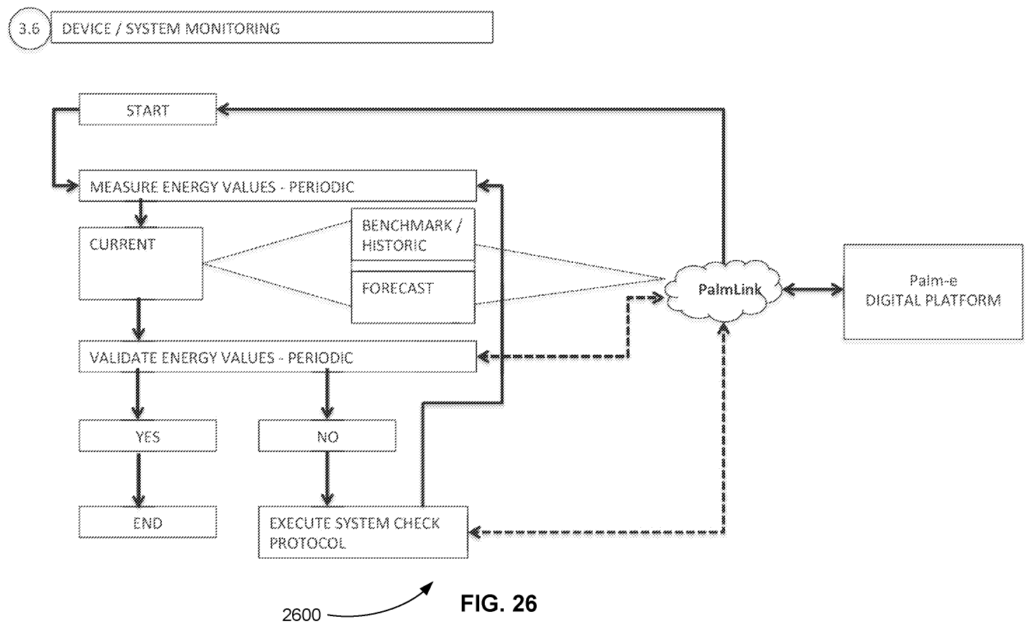

FIG. 26 is a flowchart 2600 or flow diagram illustrating a process, method, operation or function to determine “device/system monitoring” of a specific clean energy system that may be used in an implementation of an embodiment of the inventive clean energy system, the Palm-e System (PeS).

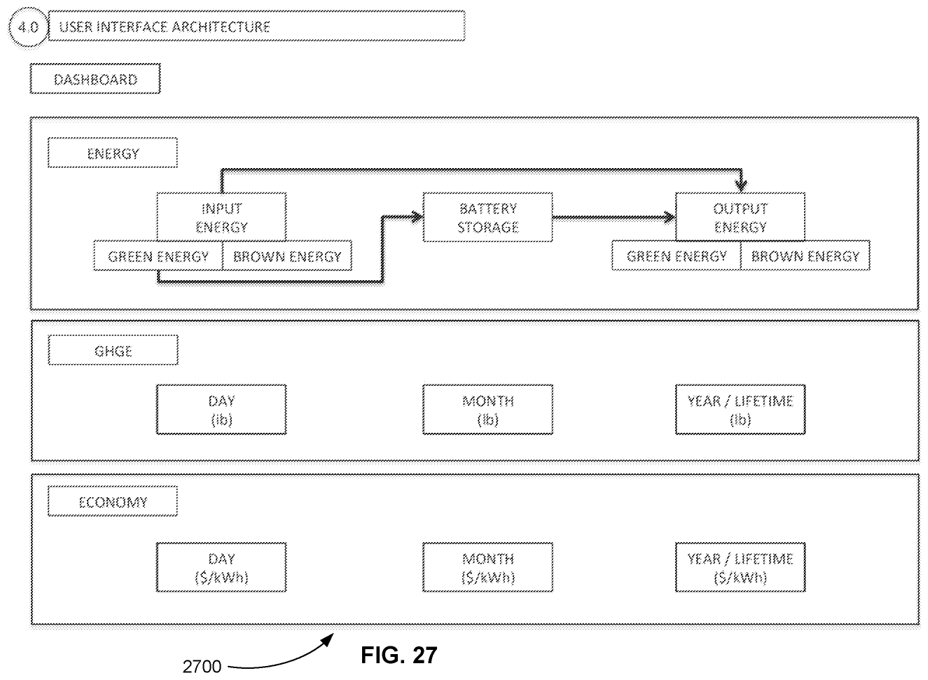

FIG. 27 is a first block diagram 2700 illustrating the user interface architecture that may be used in an implementation of an embodiment of the inventive clean energy system, the Palm-e System (PeS).

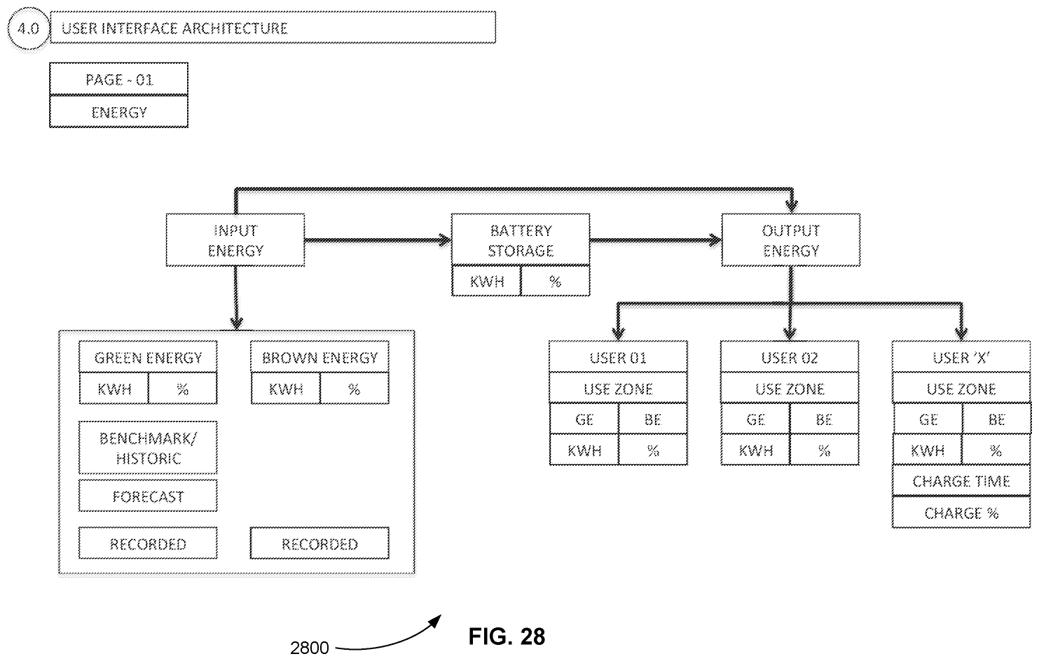

FIG. 28 is a second block diagram 2800 illustrating the user interface architecture that may be used in an implementation of an embodiment of the inventive clean energy system, the Palm-e System (PeS).

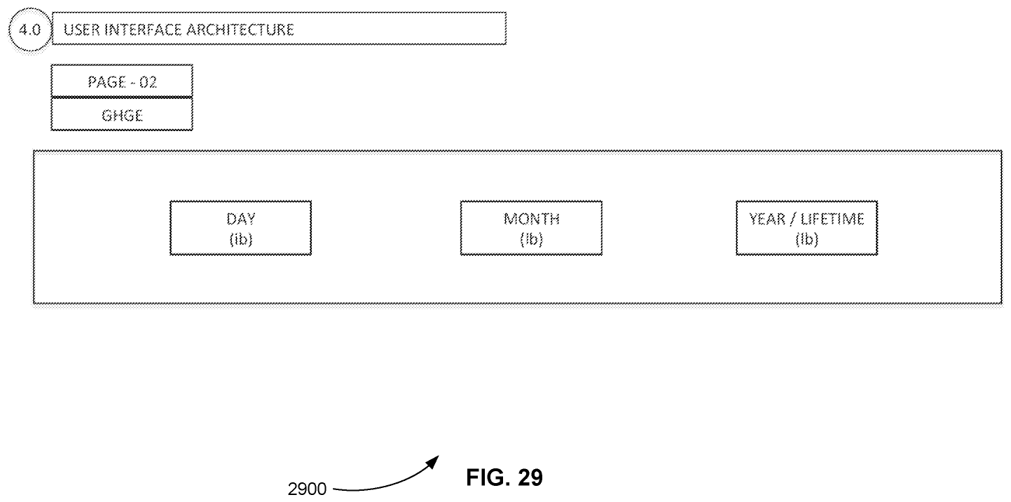

FIG. 29 is a third block diagram 2900 illustrating the user interface architecture that may be used in an implementation of an embodiment of the inventive clean energy system, the Palm-e System (PeS).

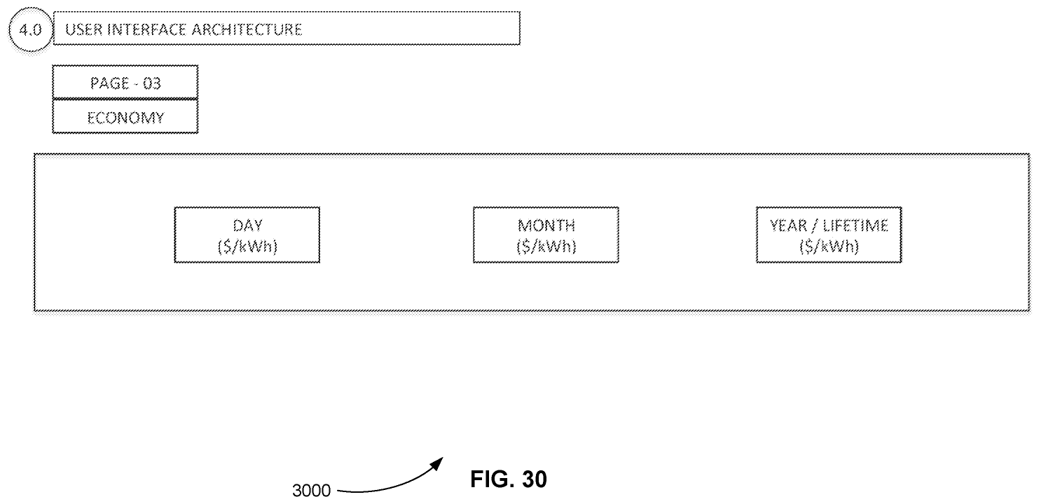

FIG. 30 is a fourth block diagram 3000 illustrating the user interface architecture that may be used in an implementation of an embodiment of the inventive clean energy system, the Palm-e System (PeS).

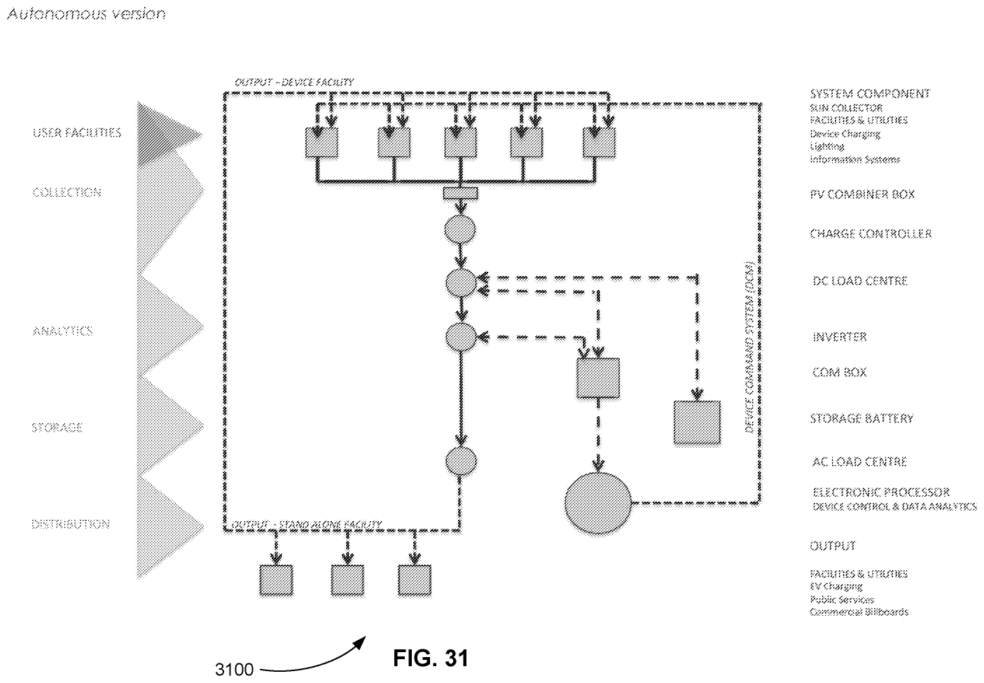

FIG. 31 is a first schematic line diagram 3100 illustrating a first version of the Palm-e SFHR ground mounted clean energy system that may be used in the implementation of an embodiment of the inventive clean energy system, the Palm-e System (PeS).

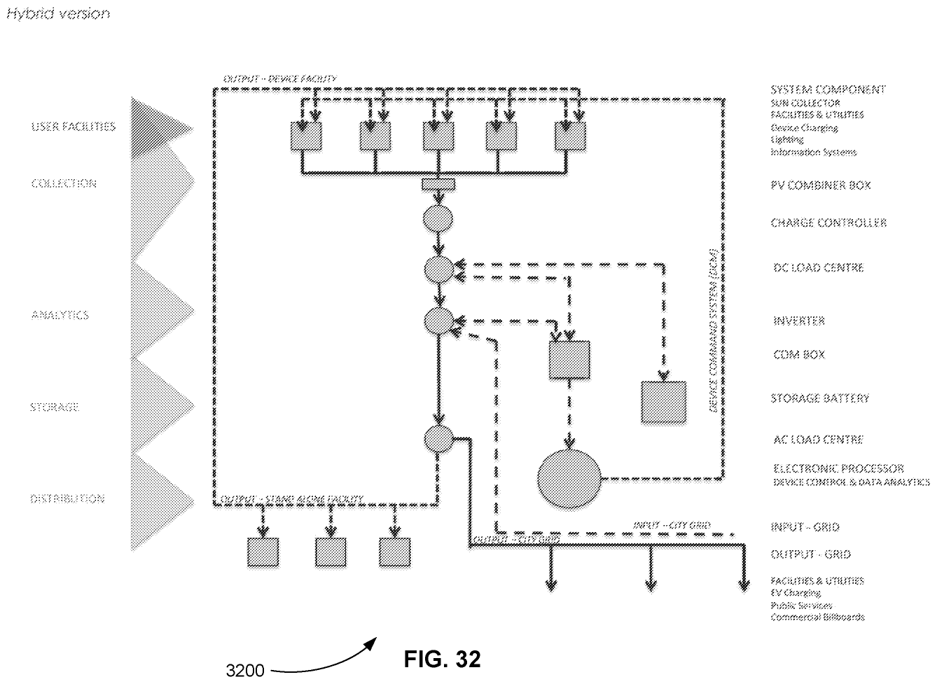

FIG. 32 is a second schematic line diagram 3200 illustrating a second version of the Palm-e SFHR ground mounted clean energy system that may be used in the implementation of an embodiment of the inventive clean energy system, the Palm-e System (PeS).

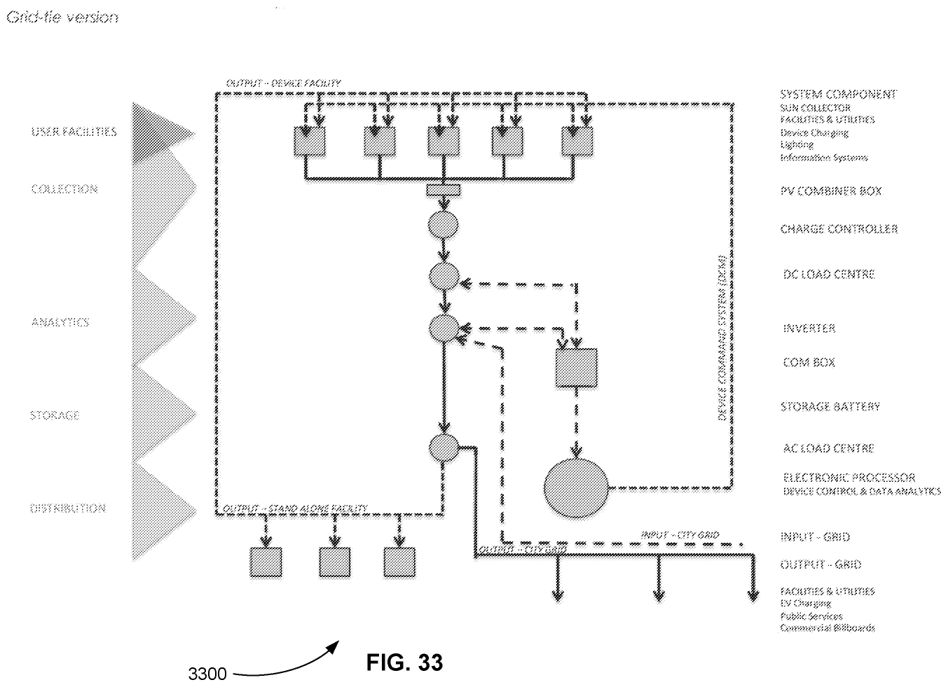

FIG. 33 is a third schematic line diagram 3300 illustrating a third version of the Palm-e SFHR ground mounted clean energy system that may be used in the implementation of an embodiment of the inventive clean energy system, the Palm-e System (PeS).

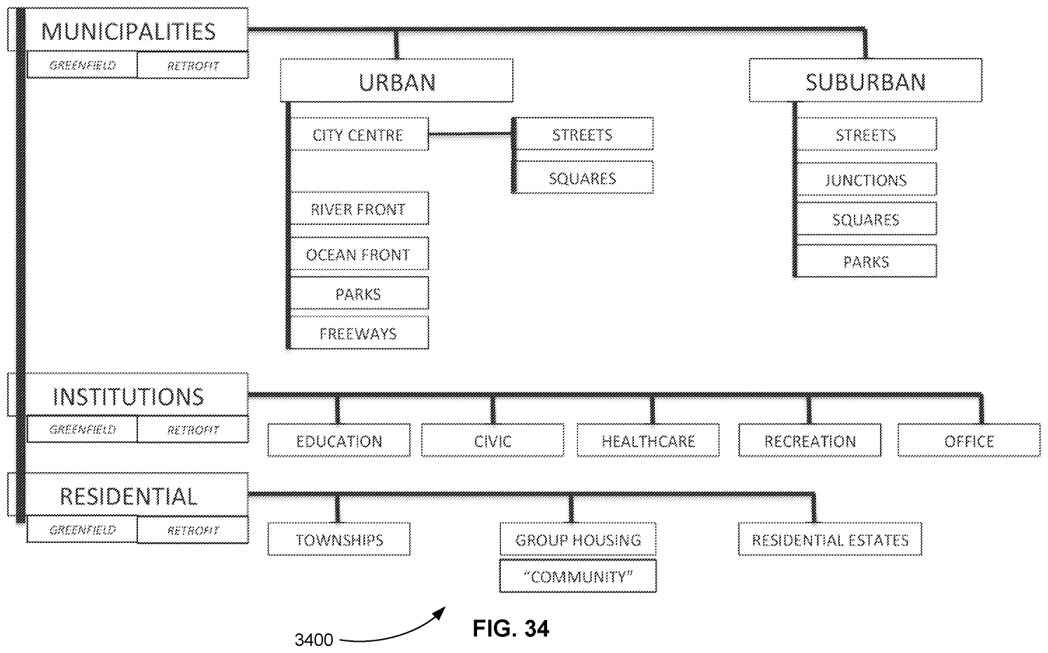

FIG. 34 is a diagram 3400 illustrating the application matrix of the Palm-e SEHR ground mounted clean energy system that may be used in the implementation of an embodiment of the inventive clean energy system, the Palm-e System (PeS).

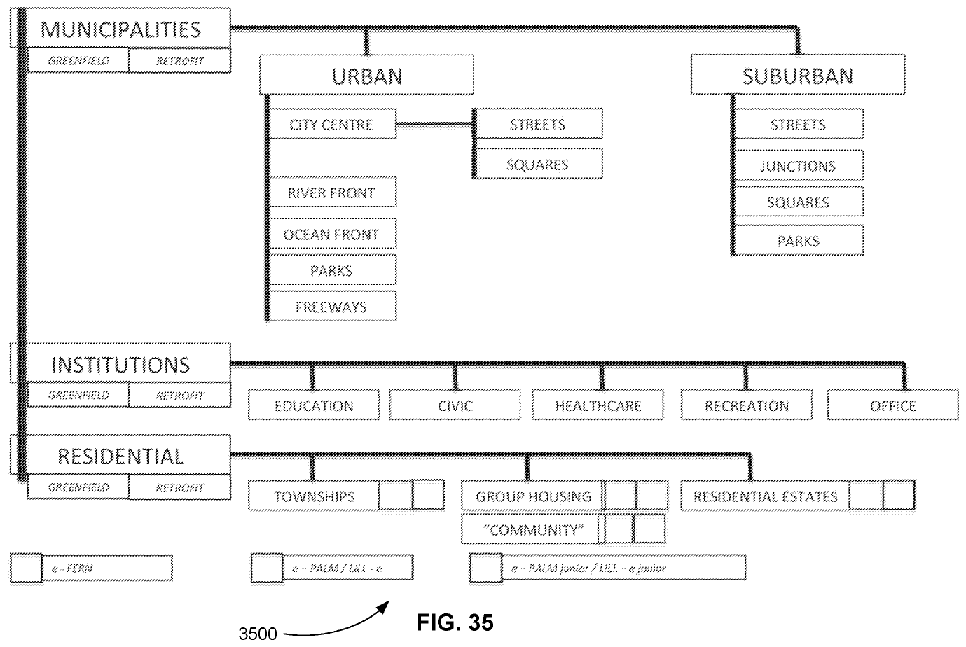

FIG. 35 is a diagram 3500 illustrating the typological application of specific device models with respect to specific user applications that may be used in the implementation of an embodiment of the inventive clean energy system, the Palm-e System (PeS).

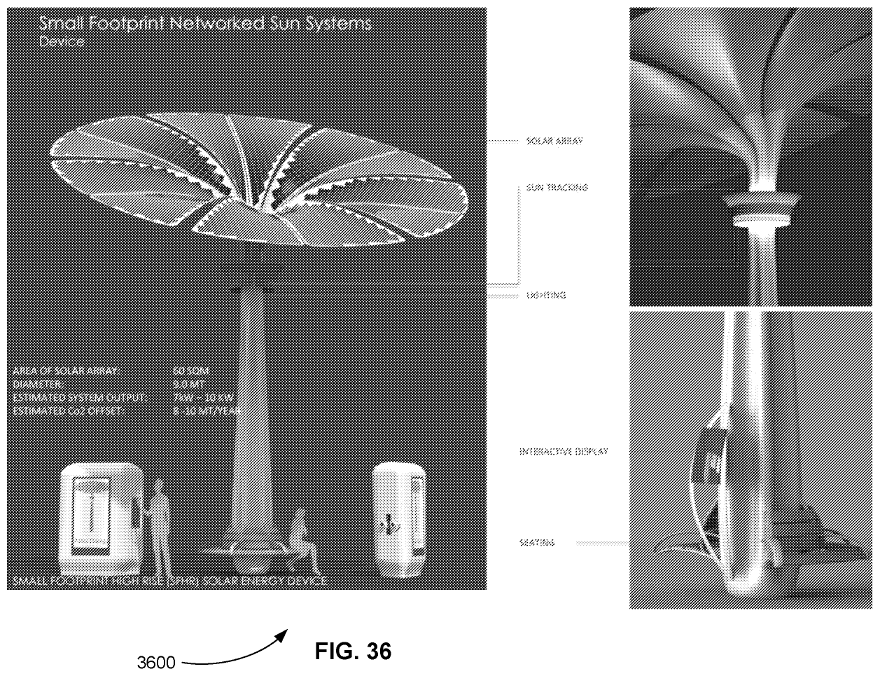

FIG. 36 is a rendering (view) 3600 of the SEHR device and certain of the components of the SFHR device illustrating the physical characteristics of the SEHR device and its primary elements, in accordance with various embodiments.

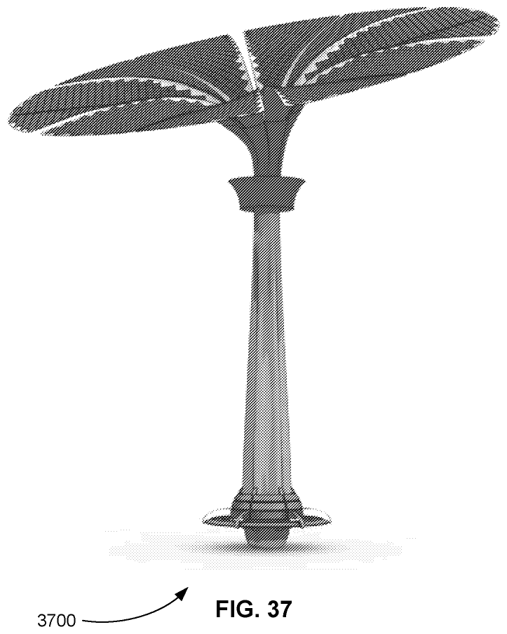

FIG. 37 is an exemplary side view 3700 of the SFHR device from an angle showing the top of the canopy, in accordance with various embodiments.

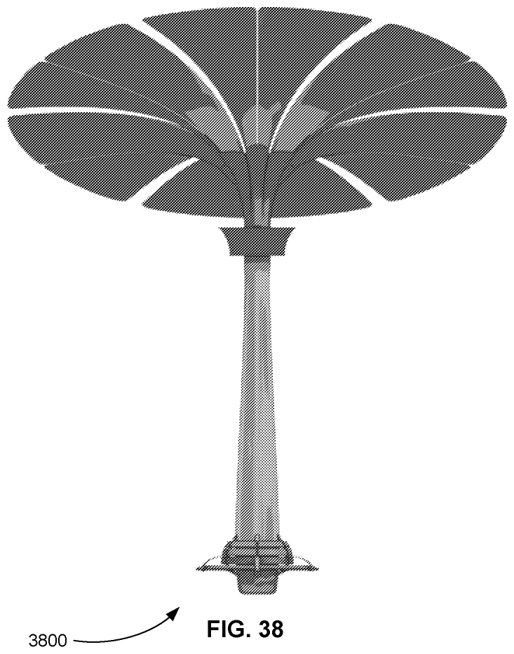

FIG. 38 is an exemplary rear view 3800 of the SFHR device from an angle showing the bottom of the canopy, in accordance with various embodiments.

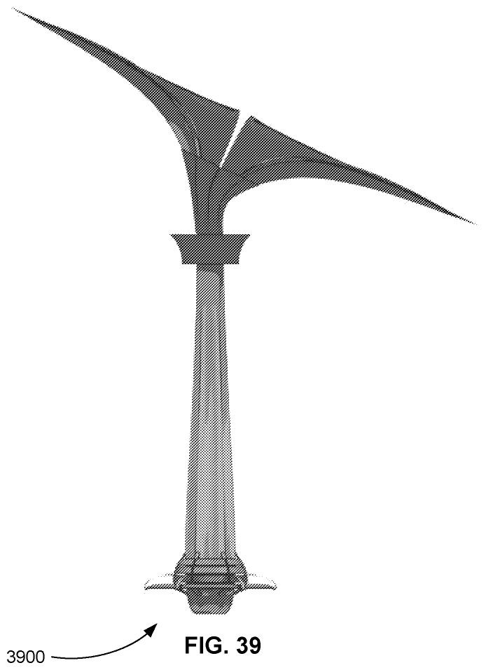

FIG. 39 is an exemplary side view 3900 of the SFHR device from an angle showing the bottom of the canopy, in accordance with various embodiments.

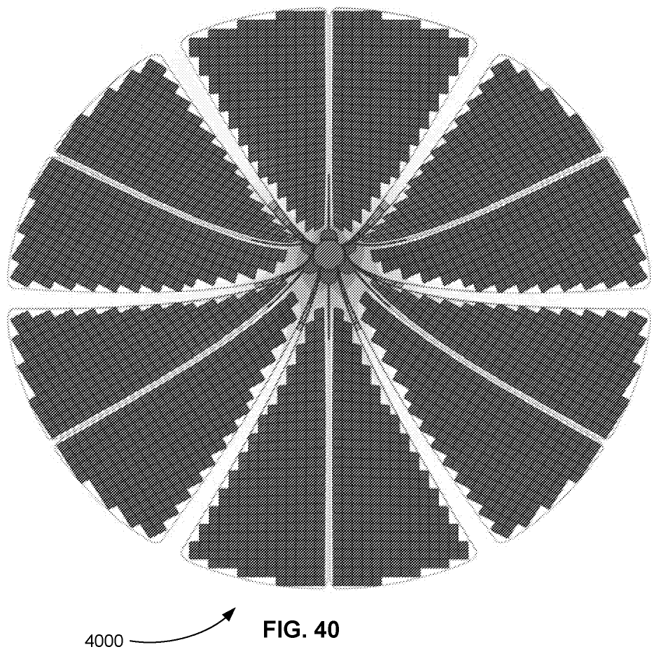

FIG. 40 is an exemplary top view 4000 of the SFHR device, in accordance with various embodiments.

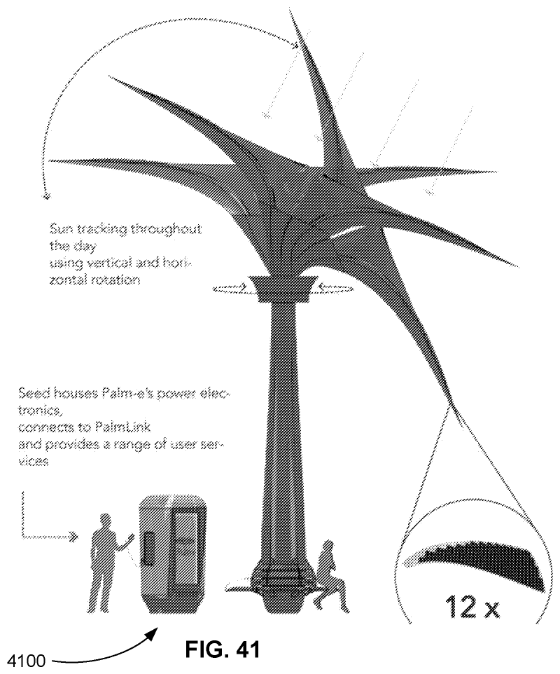

FIG. 41 is a first diagram 4100 illustrating the technology embodiments of the SFHR device and its primary components.

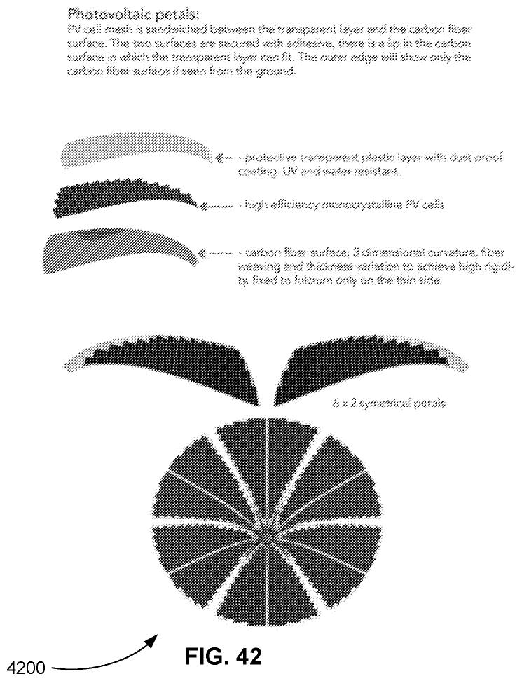

FIG. 42 is a second diagram 4200 illustrating the technology embodiments of the SFHR device and its primary components.

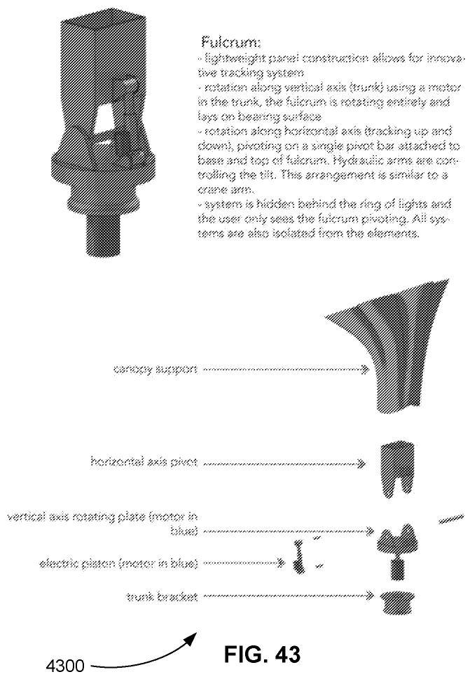

FIG. 43 is a second diagram 4300 illustrating the technology embodiments of the SFHR device and its primary components.

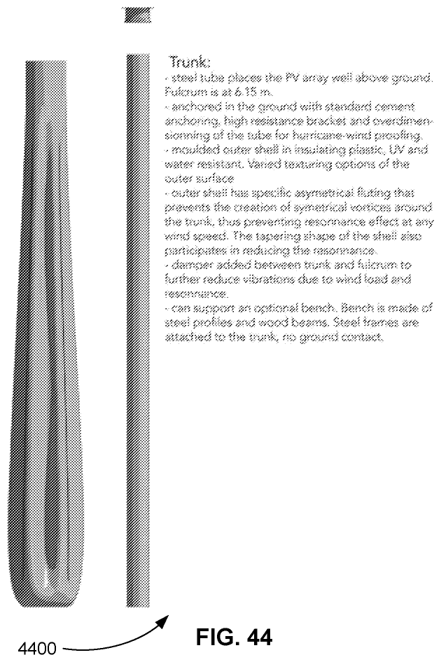

FIG. 44 is a second diagram 4400 illustrating the technology embodiments of the SFHR device and its primary components.

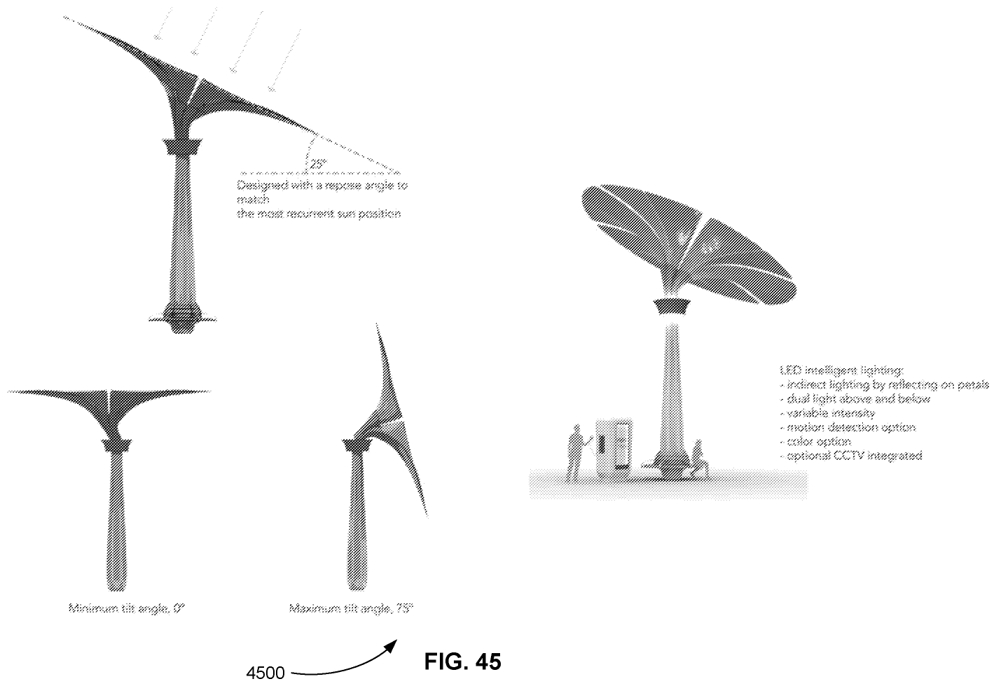

FIG. 45 is a drawing 4500 illustrating the movement characteristics of the solar corolla and certain features of the device, in accordance with various embodiments.

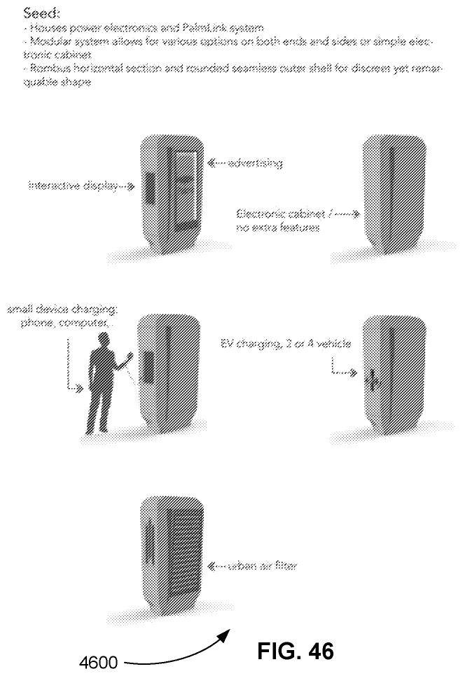

FIG. 46 is a drawing 4600 illustrating variations of the electronic cabinet-SeeD, which serves as the base station of the SFHR device, in accordance with various embodiments.

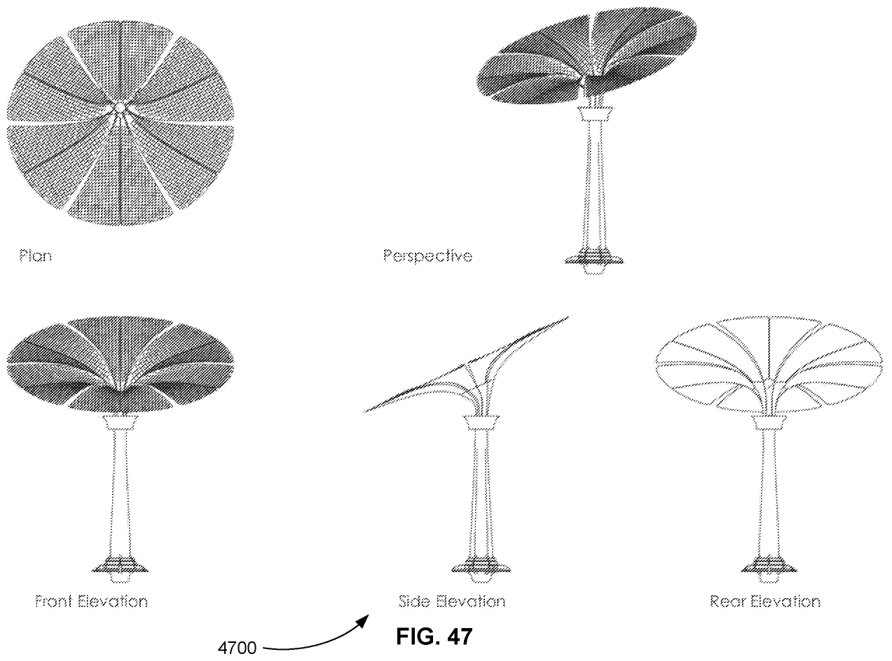

FIG. 47 is a technical drawing 4700 illustrating the physical characteristics of the SEHR device, in accordance with various embodiments.

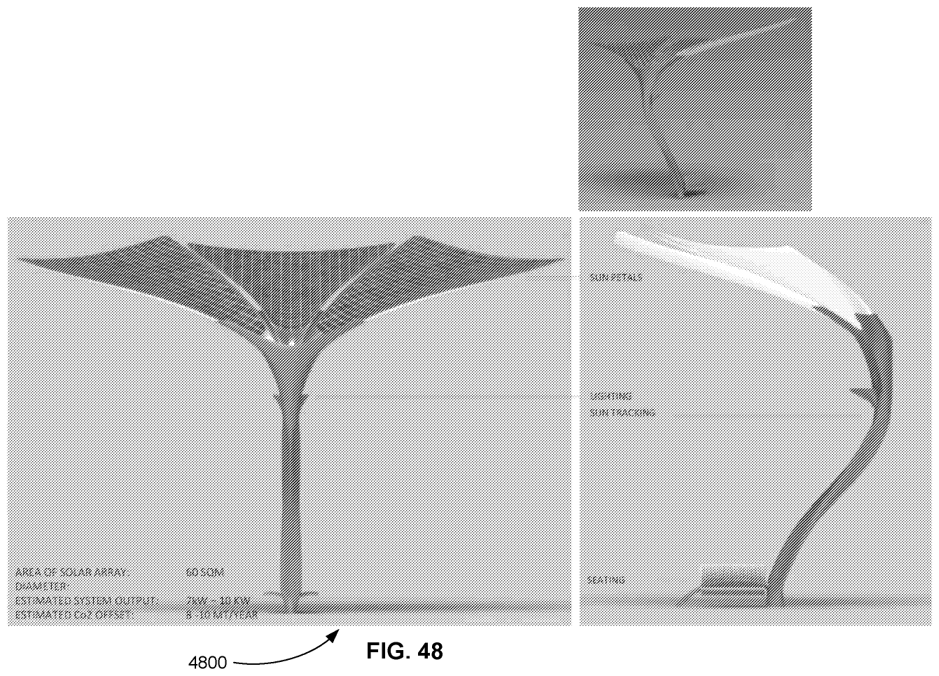

FIG. 48 is an illustration 4800 depicting a first additional typology of the inventive clean energy device that may be used in the implementation of an embodiment of the inventive clean energy system, the Palm-e System (PeS).

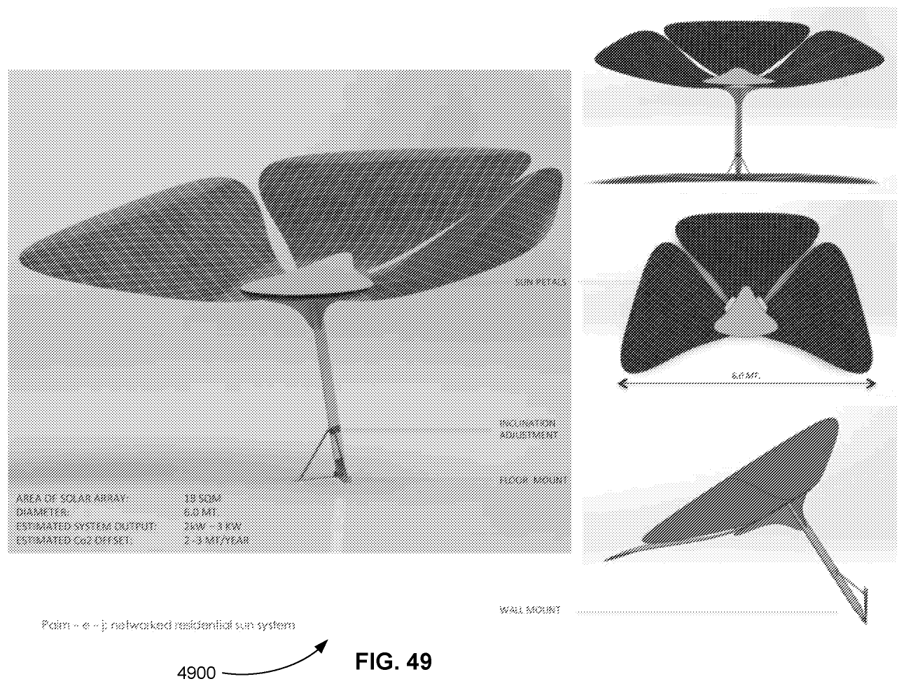

FIG. 49 is an illustration 4900 depicting a second additional typology of the inventive clean energy device that may be used in the implementation of an embodiment of the inventive clean energy system, the Palm-e System (PeS).

While the present teachings are described in conjunction with various embodiments, it is not intended that the present teachings be limited to such embodiments. On the contrary, the present teachings encompass various alternatives, modifications, and equivalents, as is appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

1. A solar panel apparatus, comprising:
a central pole;
a sun-tracking fulcrum connected to the central pole; and
a plurality of solar panel petals connected to the fulcrum, wherein the fulcrum both rotates and tilts the plurality of solar panel pedals with respect to a location of the sun.

2. The apparatus of claim 1, wherein each petal of the plurality of solar panel petals comprises an isosceles trapezoid that is curved from a shorter base to a longer base and is connected to the fulcrum at the shorter base.

3. The apparatus of claim 1, wherein each petal of the plurality of solar panel petals comprises a top transparent and protective layer, a central solar photovoltaic layer, and a lower structural layer.

4. The apparatus of claim 3, wherein the lower structural layer comprises a single surface.

5. The apparatus of claim 3, wherein the lower structural layer comprises two surfaces sandwiching a structural element.

6. The apparatus of claim 5, wherein the structural element comprises a set of multiple cross sections arranged parallel to each other.

7. The apparatus of claim 5, wherein the structural element comprises a network of metal tubes welded together.

8. The apparatus of claim 1, wherein the plurality of solar panel petals is connected to the fulcrum through a central joining piece.

9. The apparatus of claim 1, wherein the fulcrum comprises an axis rotation system where both vertical and horizontal axis rotations are done by means of slewing drives.

10. The apparatus of claim 1, wherein the fulcrum comprises an axis rotation system where vertical axis rotation is undertaken using two double or single ball or roller bearings.

11. The apparatus of claim 1, wherein the fulcrum comprises an axis rotation system where horizontal axis rotation occurs in the fulcrum between an element connecting to a petal of the plurality of solar panel petals and an element connecting to a vertical axis system.

12. The apparatus of claim 11, wherein the fulcrum comprises a ring housing that encloses the axis rotation system.

13. The apparatus of claim 12, wherein the ring housing comprises a top ring of lights to illuminate the bottom of the plurality of solar panel petals.

14. The apparatus of claim 12, wherein the ring housing comprises a bottom ring of lights to illuminate the central pole.

15. A method of assembling a solar panel apparatus, comprising connecting a sun-tracking fulcrum to a central pole; and
connecting a plurality of solar panel petals connected to the fulcrum, wherein fulcrum both rotates and tilts the plurality of solar panel pedals with respect to a location of the sun.
